(19) United States
(12) Patent Application Publication
(10) Pub. No.: US 2026/0226232 A1
(43) Pub. Date: Aug. 6, 2026

(54) MODIFIED ALKOXYLATED POLYALKYLENE IMINES OR MODIFIED ALKOXYLATED POLYAMINES

(71) Applicant: BASF SE, Ludwigshafen am Rhein (DE)

(72) Inventors: Holger TUERK, Ludwigshafen (DE); Catharina WOHLMUTH, Ludwigshafen (DE); Guido VANDERMEULEN, Ludwigshafen (DE)

(21) Appl. No.: 19/154,203

(22) PCT Filed: Feb. 12, 2024
(86) PCT No.: PCT/EP2024/053493

§ 371 Date: Aug. 6, 2025

(30) Foreign Application Priority Data
Feb. 21, 2023 (EP) 23157803.0

(51) Int. Cl. C08G 65/26; C08G 73/02; C11D 1/02; C11D 3/37; C11D 3/386; C11D 3/48

(52) U.S. Cl. CPC C08G 65/2624; C08G 65/2609; C08G 65/2615; C08G 73/0226; C08G 73/024; C11D 1/02; C11D 3/3723; C11D 3/386; C11D 3/48; C11D 2111/12; C11D 2111/14

(57) ABSTRACT

Disclosed herein are modified alkoxylated polyalkylene imines and polyamines prepared by a process including at least two steps of lactone and/or hydroxy carbon acid modification, where the second of these steps includes a combined modification with alkylene oxide to enhance the biodegradability of the polymer, a process to prepare the modified alkoxylated polyalkylene imines and polyamines, and a method of using the same, for example in laundry or dishwashing.

This invention deals with modified alkoxylated polyalkylene imine or modified alkoxylated polyamine polymers (in this present invention abbreviated as “inventive polymer” or “polymer of the invention” whenever the inventive polymers are meant), their manufacture, their uses, particularly for use in cleaning compositions such as laundry detergent compositions, and specifically for improved clay removal and/or oily/fatty soil removal in laundry care.

Detergent formulators are continuously faced with the task of developing improved products to remove a broad spectrum of soils and stains from fabrics and hard surfaces. Chemically and physico-chemically, the varieties of soils and stains spectrum range from polar soils, such as proteinaceous, clay, and inorganic soils, to non-polar soils, such as soot, carbon-black, by-products of incomplete hydrocarbon combustion, and organic soils like sebum. The removal of greasy (i.e., oily/fatty) stains has been a particularly challenging problem. This challenge has been accentuated by the recent high interest and motivation to reduce the level of surfactants in cleaning detergents for environmental, sustainability and cost reasons. A reduction of the amount of surfactants added, especially a reduction of anionic surfactants, such as linear alkyl benzene sulfonate, LAS, has typically been found to lead to an erosion of oily/fatty stain removal. Additionally, the global trend of using washing conditions at lower temperature further diminishes grease cleaning capabilities of typical detergents, since the class of oily and fatty stains shows the greatest performance drop when the temperature is decreased. On the other hand, clay soil stains, although in some instances contacting the fabric fibers with less force, nevertheless provide a specific type of soil removal problem due to the high degree of charge associated with the clay itself. This high surface charge density may act to repel some laundry ingredients, thus surfactants alone cannot remove or carry away the clay into the laundry liquor.

Another global trend is the compaction of laundry detergents, in order to improve the sustainability in terms of water usage and/or transportation costs, as well as to improve the convenience for the end consumer (e.g., single mono dose products, tabs, pouches and the like), which leads to a high market demand for new raw materials that have a higher weight-efficiency and a significantly broader performance profile.

A further strongly emerging trend is the desire to improve the “footprint” of any product, be it in terms of its origin like being from natural or renewable resources, or compared to previous products, its production in terms of production efficiency and thus reduced usage of energy, its efficiency in usage such as reduced amounts for the same performance or higher performance at the same amount levels used, its persistence in the natural environment after its usage, especially its biodegradation, since recycling is technically very challenging and therewith economically not attractive.

Hence, due to the climate change, one of the most important targets of the detergent and cleaner (D&C) industry today is to significantly lower the CO₂ emission per wash, by improving cold water conditions, improving the cleaning efficiency at low temperatures of 30° C. and below, and to lower the amounts of chemicals employed per wash, and increasing the weight-efficiency of the cleaning technologies. Another important target of the D&C industry is the need for biodegradable polymers, to improve the sustainability of the detergent formulations and to avoid the potential accumulation of the polymers or their degradation products, resulting from incomplete biodegradation of the polymers in the ecosystem, thus lowering the persistence in nature after usage of the materials.

As a result of these trends, there is a strong need for new biodegradable cleaning polymers that provide both excellent primary (i.e., soil removal) and secondary (i.e., whiteness maintenance) cleaning benefits for both hydrophobic and hydrophilic stains, and an improved biodegradability. The materials should exhibit good soil removal for oily/fatty and particulate stains and should also lead to improved whiteness maintenance, minimizing the amount of suspended and emulsified oily/fatty and particulate soil from redepositing on the surfaces of the textiles or hard surfaces. Preferably, the new ingredients would also display a synergy with other cleaning technologies, such as other cleaning polymers, surfactants and/or enzymes, known for improving solely the oily/fatty or particulate stain removal and/or whiteness of fabrics and hard surfaces, leading to further improved detergent compositions.

Alkoxylated polyalkylene imine and alkoxylated polyamine polymers, especially the class of alkoxylated hyperbranched polyethylene imine (PEI) and alkoxylated linear polypropylene imine (PPI) homo- and copolymers, are known in the literature to be able to contribute to particulate or to oily/fatty soil removal, especially at low surfactant levels and at cold water conditions (30° C. and below). However, their performance is not sufficient, both from a perspective of oily/fatty soil removal capability and also from a perspective of a broader performance profile. Moreover, their biodegradation performance generally is poor, and thus not acceptable for current and future requirements. Ideally, the polymers are readily biodegradable, i.e., show equal to or more than 60% oxygen consumption after 28 days in the OECD 301 F test or at least show equal to or more than 60% after 56 days in the OECD 301 F test. Alternatively, the polymers are inherently biodegradable in the OECD 302 B test, i.e., show equal to or more than 70% dissolved organic carbon (DOC) levels. Hence, there was a need to find improved polymer architectures with a superior performance profile, a feasible preparation process and an improved biodegradation behavior.

In the following, a summary of the most relevant publications in the field of the present invention is given.

Alkoxylated polyalkylene imines and polyamines are well known as additives for laundry detergents (e.g., EP3301154, EP3167034, EP112593 and WO2020/030469) or hard surface cleaners.

WO 2015/028191 relates to water-soluble alkoxylated polyalkylene imines having an inner block of polyethylene oxide comprising 5 to 18 polyethylene oxide units, a middle block of polyalkylene oxide comprising 1 to 5 polyalkylene oxide units and an outer block of polyethylene oxide comprising 2 to 14 polyethylene oxide units. The middle block is formed from polypropylene oxide units, polybutylene oxide units and/or polypentene oxide units. In addition, WO 2015/028191 relates to water-soluble alkoxylated polyamines. However, this disclosure is silent about the biodegradability of the polymers, while also modifications of the alkoxy chain with lactone or hydroxy carbon acid are not discussed.

WO2020/187648 relates to alkoxylated polyalkylene imines or alkoxylated polyamines, which are end-capped by a short polybutylene oxide block. The compounds described therein may be employed within, for example, cosmetic and laundry detergent formulations. However, neither lactones nor hydroxy carbon acids are used to modify the alkoxy chain of the polymer in order to enhance its biodegradability. The same holds true for GB-A 2 562 172 and WO 95/32272. U.S. Pat. No. 4,960,540 A describes alkoxylated modified diamines. An alkyl group capped polyalkoxylate is modified with e.g. acrylic acid or n-butyrolactone and subsequently attached to the diamine to generate a bis-amide structure. However, in contrast to the polymers of the present invention the non-modified diamine does not comprise any secondary amino groups. In addition, no ester groups are introduced and U.S. Pat. No. 4,960,540 A is completely silent on how biodegradation of polymers based on polyalkylene imines and polyamines comprising primary and secondary amino groups can be enhanced.

WO2012030600 A discloses a one pot reaction resulting in a random structure of the caprolactones, propylene oxides and ethylene oxides attached to a polyethyleneimine. Consequently, WO201203600 A fails to describe modified alkoxylated polyalkylene imines or modified alkoxylated polyamines, wherein more than 50% of the primary and/or secondary amino groups are reacted with a lactone and/or a hydroxy carbon acid to form an amide bond and thus, to enhance the biodegradation of the polymer. The obtained polymers are claimed only for use as oilfield demulsifiers.

WO2021165468 A describes modified (homo-) polyalkylene imines and polyamines which show better biodegradation than the previously known compounds. These alkoxylated polymers are additionally modified with lactones/hydroxy carbon acids, leading to amide functionalities between the amino group-containing core molecules and the polyalkoxylate chains in the shell, besides further ester functionalities in the polyalkoxylate chains themselves. However, said application fails to disclose a second step of reacting lactones/hydroxy carbon acids to improve biodegradability, let alone that the lactones/hydroxy carbon acids can be mixed with alkylene oxides (AO) in such a second step for an easier application.

Unpublished patent applications EP 21192170.5 and EP 21192169.7 also describe lactones/hydroxy carbon acid modified (homo-) polyalkylene imines and polyamines which show better biodegradation than the previously known compounds. However, the polymers described in these applications are different from the present polymers and not relevant for assessing inventiveness. The above-mentioned applications solely disclose separate and subsequent modification processing steps for lactone/hydroxy carbon acid and AOs. In contrast, the present invention contains a processing step of mixing lactone/hydroxy carbon acid and AOs in one single step, introducing ester groups in random position across the alkoxy chain (whereas EP 21192170.5 and EP 21192169.7 solely disclose polymers with uniformly synthesized alkoxy chains). As such, the present polymers are easier to prepare, since synthesis is reduced by at least one step, but demonstrate a similar biodegradability.

Although there have been already many alkoxylated polyalkylene imines and polyamines described in the cited publications above, including their preparation process and their use in detergents, there is still a need for polymers that exhibit further improved performance, such as an improved oily/fatty stain and clay removal in laundry, while at the same time showing an improved biodegradation behavior. This polymer profile would enable among others the design of highly concentrated and sustainable multi-benefit detergent formulations.

More specifically, there is still a strong need for new cleaning polymers that provide both excellent primary (i.e., soil removal) and secondary (i.e., whiteness maintenance) cleaning benefits, ideally for both hydrophobic and hydrophilic stains. Furthermore, a simplified manufacturing process for the modified alkoxylated polyalkylene imines and polyamines is needed as well. The present inventors surprisingly found that a combination of a first lactone/hydroxy carbon acid modification of a polyalkylene imine or polyamine with
(i) a second modification step using a lactone/hydroxy carbon acid in a mixture with AO; or
(ii) a second modification step using an alkoxylation and a third modification step using a lactone/hydroxy carbon acid in a mixture with AO; or
(iii) a second modification step using a lactone/hydroxy carbon acid in a mixture with AO and a third modification step using a lactone/hydroxy carbon acid in a mixture with AO,
   results in increased biodegradation of the alkoxylated polymer.

Furthermore, the combined addition of lactone/hydroxy carbon acid and AO in the same synthetic step provides an improved preparation process compared to the separate addition of both reactants since the two reaction steps are reduced to only one step. It also noted that the addition of a mixture of lactone/hydroxy carbon acid and AO to create an ester bond-containing alkoxy chain starting from an amide bond-modified polyalkylene imine or polyamine core leads to different polymers compared to a synthesis that is based on separate reaction steps, i.e., first reacting a polyalkylene imine or polyamine with the lactone/hydroxy carbon acid to create an amide and ester bond-modified core followed by alkoxylation with pure AO.

Additionally, it was found that the modified alkoxylated polyalkylene imines and polyamines of the invention demonstrate excellent wash performance. Thus, the present polymers combine the advantage of improved biodegradability together with superior behavior as a cleaning formulation ingredient.

Moreover, the present polymers include hyperbranched polyethylene imines, prepared via ring-opening polymerization of ethylene imine, as well as predominantly linear polypropylene imines (PPI), prepared e.g., via polycondensation of di- and oligoamines, which provide significant advantages over their structural alternatives, i.e., linear PEI and dendritic PPI, such as an easier synthesis (one-step synthesis vs. multi-step synthesis) and a more cost-effective production. Therefore, the object of the present invention is to provide novel modified alkoxylated polyalkylene imines or modified alkoxylated polyamines obtainable by a process comprising the following steps:
a) reaction of 1) at least one polyalkylene imine or at least one polyamine comprising in total a plurality of primary and secondary amino groups with 2) at least one first lactone (LA1) and/or at least one first hydroxy carbon acid (HA1), wherein 1 to 10 mol of lactone (LA1) and/or of hydroxy carbon acid (HA1) is employed per mol of NH-functionality of polyalkylene imine or polyamine, in order to obtain a first intermediate (I1),
b) reaction of the first intermediate (I1) (i) with at least one first alkylene oxide (AO1) or (ii) with a mixture of 1) at least one first alkylene oxide (AO1) with 2) at least one second lactone (LA2) and/or at least one second hydroxy carbon acid (HA2), wherein at least 5.0 mol of first alkylene oxide (AO1) and for the mixture additionally at least 1.0 mol of second lactone (LA2) and/or second hydroxy carbon acid (HA2) is employed per mol of NH-functionality of polyalkylene imine or polyamine, as employed in step a), in order to obtain a second intermediate (I2),
c) optionally reaction of the second intermediate (I2) (i) with at least one second alkylene oxide (AO2) or (ii) with a mixture of 1) at least one second alkylene oxide (AO2) with 2) at least one third lactone (LA3) and/or at least one third hydroxy carbon acid (HA3), wherein at least 5.0 mol of second alkylene oxide (AO2) and for the mixture additionally at least 1.0 mol of third lactone (LA3) and/or third hydroxy carbon acid (HA3) is employed per mol of NH-functionality of polyalkylene imine or polyamine, as employed in step a), in order to obtain a third intermediate (I3),
d) optionally reaction of the second intermediate (I2) or third intermediate (I3) with at least one fourth lactone (LA4) and/or at least one fourth hydroxy carbon acid (HA4), wherein at least 1.0 mol of fourth lactone (LA4) and/or fourth hydroxy carbon acid (HA4) is employed per mol of NH-functionality of polyalkylene imine or polyamine, as employed in step a), in order to obtain a fourth intermediate (I4),
e) optionally reaction of the second intermediate (I2), third intermediate (I3) or fourth intermediate (I4) with at least one C1-C18 alkylation or esterification reagent, in order to obtain the modified alkoxylated polyalkylene imine or the modified alkoxylated polyamine,
wherein the amount of second, third and/or fourth lactones and/or the amount of second, third and/or fourth hydroxy carbon acids is at least 1 mol per mol of NH-functionality of polyalkylene imine or polyamine, as employed in step a), and
wherein the total amount of first, second, third and/or fourth lactones and/or the total amount of first, second, third and/or fourth hydroxy carbon acids is at least 2 mol per mol of NH-functionality of polyalkylene imine or polyamine, as employed in step a), and
wherein
(i) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located terminally, and/or
(ii) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located adjacent to each other,
wherein a mixture of 1) at least one alkylene oxide (AO1, AO2) with 2) at least one lactone (LA2, LA3) and/or at least one hydroxy carbon acid (HA2, HA3) is applied in at least one of the steps b) and/or c).

The polymer of the invention may be quaternized to introduce non-permanent or permanent quaternization of the N-groups of the core of the inventive polymer.

In the following, any alkylene oxide is generically referred to as “AO”, ethylene oxide is sometimes referred to as “EO”, propylene oxide as “PO”; butylene oxide as “BuO”. “PEO” is used sometimes herein to describe polyethylene oxide homopolymers or PEO-blocks within a larger polymer structure; likewise, “PPO” describes the polypropylene oxide homopolymers or polymer-blocks within a larger polymer structure.

A polyalkylene imine or a polyamine with such side chains is sometimes also called a “modified polyalkylene imine/modified polyamine” within this disclosure to specifically distinguish from an “unmodified polyalkylene imine/unmodified polyamine” bearing no such side chains, whereas the term “polyalkylene imine/polyamine” generally herein includes any such polyalkylene imine or polyamine either bearing side chains and/or being quaternized or neither bearing side chains nor being quaternized.

A process to produce the inventive polymers is also part of this invention.

The use of such polymers of this invention for all kinds of applications for which the previously known polyamines, polyethylene imines, polypropylene imines, and their alkoxylated derivatives have been used is encompassed by this present invention as well.

Compositions comprising such polyalkylene imines or polyamines of this invention like those compositions in which the previously known polyamines, polyethylene imines, polypropylene imines, and their alkoxylated derivatives have been employed—either the inventive polyalkylene imine or polyamine instead of such known compounds or in combinations with such known compounds—forms part of this invention as well.

The term “polymer”, “polymer of the invention” or “inventive polymer”, as used herein, refers to modified alkoxylated polyalkylene imines and modified alkoxylated polyamines prepared as described below and/or in the appended claims. The before terms should be understood broadly, meaning that they encompass the non-alkoxylated (unmodified) polyalkylene imines and polyamines, such as the intermediate described as the first intermediate (I1), as well as the alkoxylated polyalkylene imines and polyamines.

Thus, subjects of the present invention are the following Embodiments 1 to 31 as defined and further explained with further embodiments hereinafter and further exemplified in the experimental section:

### EMBODIMENT 1

A modified alkoxylated polyalkylene imine or modified alkoxylated polyamine obtainable by a process comprising the steps a) to e) as follows:
a) reaction of 1) at least one polyalkylene imine or at least one polyamine comprising in total a plurality of primary and secondary amino groups with 2) at least one first lactone (LA1) and/or at least one first hydroxy carbon acid (HA1), wherein 1 to 10 mol of lactone (LA1) and/or of hydroxy carbon acid (HA1) is employed per mol of NH-functionality of polyalkylene imine or polyamine, in order to obtain a first intermediate (I1),
b) reaction of the first intermediate (I1) (i) with at least one first alkylene oxide (AO1) or (ii) with a mixture of 1) at least one first alkylene oxide (AO1) with 2) at least one second lactone (LA2) and/or at least one second hydroxy carbon acid (HA2), wherein at least 5.0 mol of first alkylene oxide (AO1) and for the mixture additionally at least 1.0 mol of second lactone (LA2) and/or second hydroxy carbon acid (HA2) is employed per mol of NH-functionality of polyalkylene imine or polyamine, as employed in step a), in order to obtain a second intermediate (I2),
c) optionally reaction of the second intermediate (I2) (i) with at least one second alkylene oxide (AO2) or (ii) with a mixture of 1) at least one second alkylene oxide (AO2) with 2) at least one third lactone (LA3) and/or at least one third hydroxy carbon acid (HA3), wherein at least 5.0 mol of second alkylene oxide (AO2) and for the mixture additionally at least 1.0 mol of third lactone (LA3) and/or third hydroxy carbon acid (HA3) is employed per mol of NH-functionality of polyalkylene imine or polyamine, as employed in step a), in order to obtain a third intermediate (I3),
d) optionally reaction of the second intermediate (I2) or third intermediate (I3) with at least one fourth lactone (LA4) and/or at least one fourth hydroxy carbon acid (HA4), wherein at least 1.0 mol of fourth lactone (LA4) and/or fourth hydroxy carbon acid (HA4) is employed per mol of NH-functionality of polyalkylene imine or polyamine, as employed in step a), in order to obtain a fourth intermediate (I4),
e) optionally reaction of the second intermediate (I2), third intermediate (I3) or fourth intermediate (I4) with at least one C1-C18 alkylation or esterification reagent, in order to obtain the modified alkoxylated polyalkylene imine or the modified alkoxylated polyamine,
wherein the amount of second, third and/or fourth lactones and/or the amount of second, third and/or fourth hydroxy carbon acids is at least 1 mol per mol of NH-functionality of polyalkylene imine or polyamine, as employed in step a), and
wherein the total amount of first, second, third and/or fourth lactones and/or the total amount of first, second, third and/or fourth hydroxy carbon acids is at least 2 mol per mol of NH-functionality of polyalkylene imine or polyamine, as employed in step a), and
wherein
(i) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located terminally, and/or
(ii) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located adjacent to each other,
wherein a mixture of 1) at least one alkylene oxide (AO1, AO2) with 2) at least one lactone (LA2, LA3) and/or at least one hydroxy carbon acid (HA2, HA3) is applied in at least one of the steps b) and/or c).

Polyalkylene imines are linear or (hyper) branched polymers comprising primary and secondary and optionally tertiary amino groups. Hyperbranched polyethylene imines are typically formed by polymerization of ethylene imine in the presence of an amine which serves as a starter for the polymer formation and typically comprise several primary, secondary and tertiary amino groups. Predominantly linear polypropylene imines (PPI) are typically formed via polycondensation of di- and oligoamines (also described as “polytransamination”) and typically comprise only two primary (located at the terminal chain ends) and multiple secondary amino groups, but no tertiary amino groups. The polyalkylene imines of the present invention are linear or hyperbranched, preferably hyperbranched and formed by a ring opening process of alkylene imine monomers, preferably of ethylene imine. Alternatively, polyethylene imines that are synthesized by hydrolysis of polyoxazolines and that exhibit a solely linear structure, can be employed within the scope of the present invention. Within the scope of the present invention are also polypropylene imine homo- and copolymers prepared by polycondensation of di- and oligoamines, preferably by (co-)polymerization of 1,3-propylene diamine, that lead to linear polyalkylene imines, more specifically to polypropylene imine homo- and copolymers (e.g., WO2014131649A1 and WO2021254929 A1). The term “hyperbranched”, as used herein, in relation to alkoxylated polyalkylene imines refers to its definition as known to those of skill in the art. A hyperbranched polymer comprises generally polydisperse branched macromolecules which are preferably prepared in a single synthetic polymerization step that forms imperfect branches, generally in a non-deterministic way. However, there are many preferable synthetic strategies known in the art to prepare hyperbranched polymers with lower polydispersity. They are typically characterized by their degree of branching (DB). The imine-based hyperbranched polymer of the invention comprises tertiary, secondary, and primary amines before being alkoxylated, in which case the primary amines might as an example be converted to secondary and/or tertiary amines and secondary amines might, for example, be converted to tertiary amines, leading to the same imperfect branched structure. The term degree of branching (DB) has a meaning known in the field of branched macromolecules, and use herein is consistent with that meaning. A preferable definition is provided, for example, in C. J. Hawker, R. Lee, and J. M. J. Fréchet (1991), “The One-Step Synthesis of Hyperbranched Dendritic Polyesters,” J. Am. Chem. Soc., 113:4583, which is incorporated herein by reference in its entirety.

The term “polyamine”, as used herein, comprises all structures falling under formula (I) as described below and not falling under the definition of the polyalkylene imines as defined above. Thus, the term “polyamines” includes saturated and unsaturated, linear or cyclic or branched organic compounds with a defined molecular weight, comprising at least two terminal primary amino groups and at least one secondary amino group located between the terminal amino groups. Depending on the chain length, polyamines are colorless to yellowish in color and are either liquid or solid at room temperature. Preferably, the polyamines used in step a) do not comprise any tertiary amino groups. Typical examples for such polyamines are N-(2-aminoethyl)-1,3-propylene diamine (N3-Amine), N,N′-Bis-(3-aminopropyl)-ethylene diamine (N4-Amine), Dipropylene triamine (DPTA), Tripropylene tetramine (TPTA), Diethylene triamine (DETA), N-(3-aminopropyl)-diethylene triamine (TETA) and N-(3-aminopropyl)-triethylene tetramine (TEPA).

The term “plurality”, as used herein, is defined as three or more than three. In the context of the total amount of amino groups this means that the polyalkylene imines and polyamines used to prepare the polymers of the invention comprise at least 3, 4, 5, 6, 7, 8, 9 or more amino groups (i.e., the sum of all primary, secondary and tertiary amino groups). In detail, this means at least 2, 3, 4, 5, 6, 7, 8, 9 or more are primary amino groups and at least 1, 2, 3, 4, 5, 6, 7, 8, 9 or more is/are secondary amino group(s).

For the purpose of the present invention, the expression/term “modified” relates to the presence of (predominately) hydrophobic oligo- or polyester blocks based on lactones and/or hydroxy carbon acids, such as caprolactone and/or lactic acid, or a combination of such lactones or hydroxy carbon acids with alkylene oxides, such as ethylene oxide and/or propylene oxide attached to the inventive polymers to result in the modified compound. The presence of alkylene oxides within or next to the (predominately) hydrophobic polyester blocks leads to an amphiphilic nature and thus to excellent cleaning properties of the inventive polymers in detergent applications. Inventive polymers bearing such modification are also called being “alkoxylated” and/or “modified and alkoxylated”.

Within the context of the present invention, the term “NH-functionality” is defined as follows: A primary amino group (—NH2) has two NH-functionalities, a secondary amino group only one NH-functionality, and a tertiary amino group, by consequence, has no reactive NH-functionality. The term “mixture”, as used herein, refers to a substantially even distribution of an alkylene oxide (AO1, AO2 or AO3) as further described below and a lactone (LA1, LA2, LA3 and LA4) and/or a hydroxy carbon acid (HA1, HA2, HA3 and HA4), whereas the substances include solid, liquid, or gaseous forms and even any mixture thereof.

The term “1 to 10 mol first lactone (LA1) and/or at least one first hydroxy carbon acid (HA1)” means that preferably 2 to 8, more preferably 3 to 7, even more preferably 4 to 6 and most preferably 4.5 to 5 mol of the above-mentioned substances can be employed per mol of NH-functionality of polyalkylene imine or polyamine.

“At least 5 mol of first/second alkylene oxide” means that at least 6, at least 7, at least 10 or at least 15 mol can be employed. Similarly, the term “at least 1 mol of second, third or fourth lactone and/or hydroxy carbon acid”, as used herein, means that at least 1.5, at least 2, at least 2.5, at least 3, at least 4 or at least 5 mol of the above-mentioned substances can be employed per mol of NH-functionality of polyalkylene imine or polyamine.

“C1-C18 alkylation or esterification reagent”, as used herein, means that the alkylation reagent has preferably 2 to 15, more preferably 3 to 10 and most preferably 4 to 8 carbon atoms. Comparably, the esterification reagent also has preferably 2 to 15, more preferably 3 to 10 and most preferably 4 to 8 carbon atoms.

For the purposes of the present invention, definitions such as C1-C18-alkylation or esterification reagent, for example, to depict a hydrocarbon substituent on a nitrogen, carbon or oxygen atom of the inventive polymer, mean that this substituent (radical) comprises in case of “C1-C18-alkylation or esterification reagent” an alkyl or alkylene radical having from 1 to 18 carbon atoms. The radical can be either linear or branched or optionally cyclic and can be saturated or unsaturated. Alkyl or alkylene radicals which have both a cyclic component and a linear component likewise come within this definition. The same applies to other alkyl or alkylene radicals such as a C1-C4-alkyl or alkylene radical. Examples of alkyl radicals are methyl, ethyl, n-propyl, sec-propyl, n-butyl, sec-butyl, isobutyl, 2-ethylhexyl, tert-butyl (tert-Bu/t-Bu), pentyl, hexyl, heptyl, cyclohexyl, octyl, nonyl, decyl, dodecyl, tetradecyl, hexadecyl and octadecyl. More specifically, typical alkylation reagents such as alkyl halides and/or carbon acids and/or carbon acid derivatives such as carbon acid anhydrides, carbon acid esters or carbon acid halides fall under the definition of the C1-C18-alkylation or esterification reagent, including unsubstituted or at least monosubstituted C₁-C₁₈-alkyl, C₇-C₁₈-aralkyl, —(CO)—C1-C18-alkyl, —(CO)—C₂-C₁₈-alkenyl and/or —(CO)—C₇-C₁₈-aralkyl, wherein the substituents are selected from —COOH or a salt thereof. Preference is given to carbon acid anhydrides, specifically to alkyl-chain-substituted succinic anhydrides, examples being C6 to C18-substituted succinic anhydrides. Examples of products commercially available include Pentasize 8 or Pentasize 68 (C18 alkenyl succinic anhydride or C16/C18 alkenyl succinic anhydride, respectively, from Trigon Chemie GmbH).

Other such typical abbreviations such as “C2-C₁₂ alkylene oxides” and the like have their ordinary meaning as used in this field of organic chemistry

### EMBODIMENT 2

The modified alkoxylated polyalkylene imine or modified alkoxylated polyamine according to Embodiment 1, wherein the at least one polyalkylene imine or the at least one polyamine comprises at least 2, 3, 4, 5, 6, 7, 8, 9 or more primary and/or at least 1, 2, 3, 4, 5, 6, 7, 8, 9 or more secondary amino groups and wherein in the modified alkoxylated polyalkylene imine or modified alkoxylated polyamine more than 50%, preferably at least 75% and even more preferably at least 80% of said primary and/or secondary amino groups are reacted with the first lactone (LA1) and/or the first hydroxy carbon acid (HA1) to form an amide bond.

Thus, in a preferred Embodiment in the modified alkoxylated polyalkylene imine or modified alkoxylated polyamine more than 50%, preferably at least 75% and even more preferably at least 80% of said primary amino groups are reacted with the first lactone (LA1) and/or the first hydroxy carbon acid (HA1) to form an amide bond.

Further, in another preferred Embodiment in the modified alkoxylated polyalkylene imine or modified alkoxylated polyamine more than 50%, preferably at least 75% and even more preferably at least 80% of said secondary amino group(s) is/are reacted with the first lactone (LA1) and/or the first hydroxy carbon acid (HA1) to form an amide bond.

In principle, polyalkylene imine and also polyamines generally may be linear or branched. The polyalkylene imines and polyamines used to prepare the polymers of the present invention comprise in total a plurality of primary and secondary amino groups.

By consequence, the inventive polymers have a basic skeleton (backbone, before any modification/alkoxylation), which comprises primary, secondary and optionally tertiary nitrogen atoms which are joined by i) alkylene radicals or ii) or by an etheralkyl unit according to general formula (III) (depicted as R):
primary amino moieties terminate the main and also the side chains of the basic skeleton and whose hydrogen atoms may be subsequently replaced by side chains when modified with alkylene oxides and/or lactones/hydroxy acids:

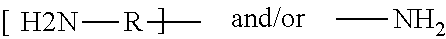

secondary amino moieties whose hydrogen atom may be subsequently replaced by side chains when modified with alkylene oxides and/or lactones/hydroxy acids:

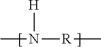

tertiary amino moieties which branch the main chain and the side chains:

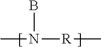

For the sake of completeness, it is indicated that the variable B i) indicates the further branching of the polyalkylene imine or polyamine backbone of compounds according to general formula (I) and comprises at least one fragment with at least one further amino moiety including a two times, three times or even higher degree of branching or ii) represents an identical or different C1-C18-alkyl unit. The degree of branching may be determined, for example, by NMR-spectroscopy such as ¹H-NMR or preferably ¹³C-NMR spectroscopy.

In preferred Embodiments, the polyalkylene imine and/or polyamines of the invention comprise in total a plurality of primary, secondary and optionally tertiary amino groups, whereas the alkoxylated polyalkylene imine/polyamine and of the modified alkoxylated polyalkylene imine/modified alkoxylated polyamine comprise only tertiary amino groups, accompanied by amide groups formed in the reaction with lactones and/or hydroxy carbon acids in step (a).

The amine number for primary, secondary, and tertiary amines is determined in accordance with the standard DIN EN ISO 9702.

### EMBODIMENT 3

The modified alkoxylated polyalkylene imine or modified alkoxylated polyamine according to Embodiment 1 or 2 comprising a plurality of alkoxy chains, wherein at least 50%, preferably at least 75% and even more preferably at least 95% of said alkoxy chains comprise a structure according to formula (IV)

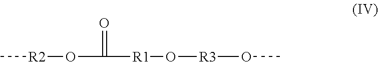

wherein
the dotted lines indicate the bonds between the structure of formula (IV) and the alkoxy chain,
R1 represents linear or branched C2-C10-alkylene radicals, more preferably linear or branched C2-C5-alkylene radicals;
R2 represents linear or branched C2-C12-alkylene radicals, more preferably 1,2-ethylene, 1,2-propylene and/or 1,2-butylene, most preferably 1,2-ethylene and 1,2-propylene; and
R3 represents linear or branched C2-C12-alkylene radicals, more preferably 1,2-ethylene, 1,2-propylene and/or 1,2-butylene, most preferably 1,2-ethylene and 1,2-propylene.

### EMBODIMENT 4

The modified alkoxylated polyalkylene imine or modified alkoxylated polyamine according to any of Embodiments 1 to 3, wherein the alkylene oxides AO1 and AO2 are independently of each other selected from the group consisting of C₂-C₁₂-alkylene oxides, preferably ethylene oxide, propylene oxide and butylene oxide.

In preferred Embodiments, the alkylene oxides AO1 and AO2 employed consecutively for the synthesis of the modified alkoxylated polyalkylene imine or polyamine are different from each other.

For clarifications of this Embodiment, this means that AO1 and AO2 may be identical or different from each other

AO1 is preferably ethylene oxide or a mixture of predominantly ethylene oxide and propylene oxide and/or butylene oxide.

AO2 is preferably propylene oxide or a mixture of predominantly propylene oxide and ethylene oxide and/or butylene oxide.

### EMBODIMENT 5

The modified alkoxylated polyalkylene imine or alkoxylated polyamine according to any of Embodiments 1 to 4, wherein the polyalkylene imine or polyamine of step a) is defined according to formula (I)

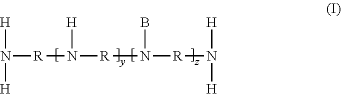

in which the variables are each defined as follows:
R represents identical or different i) linear or branched C₂-C₁₂-alkylene radicals or ii) an etheralkyl unit of the following formula (III):

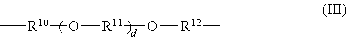

in which the variables are each defined as follows:
   R¹⁰, R¹¹, R¹² represent identical or different, linear or branched C₂-C₆-alkylene radicals and
   d is an integer having a value in the range of 0 to 50,
B represents
   (i) a continuation of the polyalkylene imine or polyamine by branching; and/or
   (ii) identical or different C1-C18-alkyl;
y is an integer having a value of at least 1,
Z is an integer having a value of 0-150.

### EMBODIMENT 6

The modified alkoxylated polyalkylene imine or alkoxylated polyamine according to any of Embodiments 1 to 5, wherein the modified alkoxylated polyalkylene imine or alkoxylated polyamine comprises a structural element according to formulas (Ia) and/or (Ib)

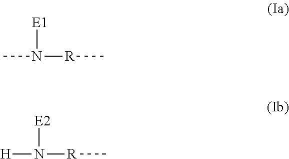

for both formulas the variables are defined as follows:
the dotted lines indicate bonds to the remaining parts of the modified alkoxylated polyalkylene imine or alkoxylated polyamine;
R is defined as above;
E1 and E2 represent a residue according to formula (IIa)

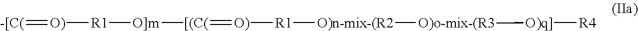

wherein -mix- defines that the flanking units are randomly distributed among each other, wherein m is an integer having a value of 1-20, n is an integer having a value of 1-20, o is an integer having a value of 5-150, q is an integer having a value of 0 or a value of 5-150, wherein the sum of m and n (m+n) is at least 2, and
R1 represents linear or branched C₂-C₁₀-alkylene radicals, more preferably linear or branched C₂-C₅-alkylene radicals;
R2 represents linear or branched C₂-C₁₂-alkylene radicals, more preferably 1,2-ethylene, 1,2-propylene and/or 1,2-butylene, most preferably 1,2-ethylene;
R3 represents linear or branched C₂-C₁₂-alkylene radicals, more preferably 1,2-ethylene, 1,2-propylene and/or 1,2-butylene, most preferably 1,2-propylene and/or 1,2-butylene; and
R4 represents hydrogen, unsubstituted or at least monosubstituted C₁-C₁₈-alkyl, C₇-C₁₈-aralkyl, —(CO)—C₁-C₁₈-alkyl, —(CO)—C₂-C₁₈-alkenyl and/or —(CO)—C₇-C₁₈-aralkyl, wherein the substituents are selected from —COOH or a salt thereof, more preferably hydrogen, methyl, ethyl or monosubstituted —(CO)—C₂-C₁₈-alkenyl, most preferably hydrogen,
wherein R² and R³ are not identical.

Alternatively, or in addition, the modified alkoxylated polyalkylene imine or alkoxylated polyamine comprises a structural element according to formulas (Ia) and/or (Ib) as described above,
wherein R of formulas (Ia) and (Ib) is as defined above and
E1 and E2 each represent a residue according to formula (II)

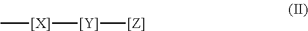

wherein
X represents a segment according to formula (IIIa)

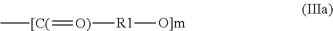

Y represents a segment according to formula (IIIb)

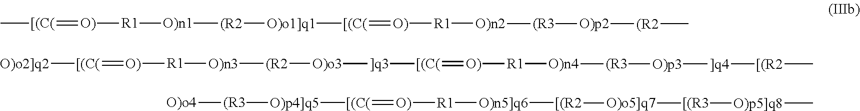

Z represents hydrogen, unsubstituted or at least monosubstituted C₁-C₁₈-alkyl, C₇-C₁₈-aralkyl, —(CO)—C₁-C₁₈-alkyl, —(CO)—C₂-C₁₈-alkenyl and/or —(CO)—C₇-C₁₈-aralkyl, wherein the substituents are selected from —COOH or a salt thereof, more preferably hydrogen, methyl, ethyl or monosubstituted —(CO)—C₂-C₁₈-alkenyl, most preferably hydrogen,
wherein
m is an integer having a value in the range of 1 to 20,
n1-5 are each independent and are an integer having a value in the range of 0 to 20,
at least one of the n1-n5 having a value of at least 1,
o1-5 are each independent and are an integer having a value in the range of 0-150,
p1-5 are each independent and are an integer having a value in the range of 0-150,
q1-8 are each independent and are an integer having a value in the range of 0-150,
wherein the subunits q1-q8 in the segment Y are randomly distributed among each other,
wherein the sum of repeating units —(C(═O)—R1-O)— in segments X and Y is on average at least 3 (m+n1*q1+n2*q2+n3*q3+n4*q4+n5*q6>=2),
wherein the sum of repeating units-(R2-O)-in segment Y is on average at least 5 (o1*q1+o2*q2+o3*q3+o4*q5+o5*q7>=5),
wherein
R1 represents linear or branched C2-C10-alkylene radicals, more preferably linear or branched C2-C5-alkylene radicals;
R2 represents linear or branched C2-C12-alkylene radicals, more preferably 1,2-ethylene, 1,2-propylene and/or 1,2-butylene, most preferably 1,2-ethylene;
R3 represents linear or branched C2-C12-alkylene radicals, more preferably 1,2-ethylene, 1,2-propylene and/or 1,2-butylene, most preferably 1,2-propylene and/or 1,2-butylene, wherein R2 and R3 are not identical.

### EMBODIMENT 7

The modified alkoxylated polyalkylene imine or modified alkoxylated polyamine according to any of Embodiments 1 to 6, wherein
i) all steps a) to e) are carried out as a one-step reaction, optionally in the presence of a catalyst, and/or
ii) the weight average molecular weight (Mw) of the polyalkylene imine or of the polyamine employed in step a) lies in the range of 50 to 20 000 g/mol, preferably in the range of 150 to 10 000 g/mol, more preferably in the range of 200 to 5000 g/mol.

The person skilled in the art knows how to determine/measure the respective weight average molecular weight (M_{W}). This can be done, for example, by size exclusion chromatography (such as GPC, e.g., in combination with light scattering). Preferably, M_{W} values are determined by the method as follows: OECD TG 118 (1996), which means in detail

OECD (1996), Test No. 118: Determination of the Number-Average Molecular Weight and the Molecular Weight Distribution of Polymers using Gel Permeation Chromatography, OECD Guidelines for the Testing of Chemicals, Section 1, OECD Publishing, Paris, also available on the internet, for example, under https://doi.org/10.1787/9789264069848-en.

Molecular weights of the polyalkylene imine or polyamine starting materials may be determined by gel permeation chromatography (GPC). The measurements may be carried out on a combination of the following three columns: HFIP-LG Guard, PL HFIPGEL and PL HFIPGel. Elution may be performed at a constant flow rate of 1 mL/min with Hexafluoroisopropanol and 0.05 wt % Potassium trifluoroacetate. The injected sample may be prefiltered over a Millipore Millex FG (0.2 μm), 50 μL may be injected with a concentration of 1.5 mg/mL (diluted in eluent). The effluent may be monitored by the UV detector DRI Agilent 1100 at λ=230 and 280 nm. The calibration may be carried out using PMMA standards (PSS, Mainz, Germany) with a molecular weight from 800 to 2 200 000 g/mol. Values outside of the calibration range may be extrapolated. Molecular weights of the modified alkoxylated polyalkylene imines or modified alkoxylated polyamines may be determined by gel permeation chromatography (GPC). The measurements may be carried on a combination of two columns (styrene-divinylbenzene and polyester copolymer, both 25 cm in length and 4.6 mm in diameter), using 0.05 wt % potassium trifluoroacetate in Hexafluoroisopropanol as eluent. The molecular weights may be obtained by using an RI detector and PEO standards (Polymer Laboratories/Agilent, USA) for calibration. In addition, the absolute molar mass may be determined by multi angle light scattering (MALLS).

For the sake of completeness, for polyamines in step a) of the inventive process, it is indicated that when single organic compounds such as N-(2-aminoethyl)-1,3-propylene diamine (N3-Amine), N,N′-Bis-(3-aminopropyl)-ethylene diamine (N4-Amine), Dipropylene triamine (DPTA), Tripropylene tetramine (TPTA), Diethylene triamine (DETA), N-(3-aminopropyl)-diethylene triamine (TETA) and N-(3-aminopropyl)-triethylene tetramine (TEPA) are used, the weight average molecular weight (Mw) is identical to the number average molecular weight (Mn). Therefore, Mw and Mn are identical to their molar mass.

“Mw” is the weight average molecular weight and “Mn” is number average molecular weight. The respective values of Mw and/or Mn can be determined as described within the experimental section below.

The molar mass distribution Mw/Mn obtained by GPC is equal to the polydispersity index (PDI), the PDI being without unit [g/mol/g/mol]).

### EMBODIMENT 8

The modified alkoxylated polyalkylene imine or modified alkoxylated polyamine according to any of Embodiments 1 to 7, wherein said modified alkoxylated polyalkylene imine or modified alkoxylated polyamine demonstrates at least 20%, preferably at least 40% or more preferably at least 60% biodegradability according to standard OECD 301F within 56 days, preferably within 28 days.

For the purposes of this invention, aerobic biodegradation in wastewater according to OECD 301F is expressed as a percentage of the theoretical oxygen demand (ThOD, which is measured by the elemental analysis of the compound of interest), which is needed to completely biodegrade the polymer sample. Thus, the amount of oxygen taken up by the microbial population during biodegradation of the test substance (corrected for uptake by blank inoculum, run in parallel) is expressed as a percentage of ThOD. The obtained values are preferably measured in triplicate using the OECD 301F manometric respirometry method. The consumption of oxygen is determined by measuring the change in pressure in the apparatus using an OxiTop® C (Xylem 35 Analytics Germany Sales GmbH & Co KG). Details for the tests performed are given in the experimental section below.

The present invention provides modified polyalkylene imines and modified polyamines, which are alkoxylated and wherein particularly the alkoxy chains and the incorporated amide and potentially further ester groups between the polyalkylene imine or polyamine backbone and the alkoxy chains and furthermore additionally incorporated ester groups within the alkoxy chains, introduced by using mixtures of alkylene oxides and lactones and/or hydroxy acids, in at least one of the process steps b) and/or c), significantly contribute to the biodegradation value. Thus, the combined core-shell-product (i.e., the modified alkoxylated polyalkylene imine and modified alkoxylated polyamine) exhibits a significant biodegradation value. Moreover, these inventive polymers demonstrate also wash performance comparable to currently used products.

### EMBODIMENT 9

The modified alkoxylated polyalkylene imine according to Embodiments 5 to 7, wherein the variables are each defined as follows:
R is ethylene and/or propylene, preferably ethylene;
the sum of y+z is an integer having a value in the range of 4 to 200, preferably in the range of 10 to 150.

Preferably, the weight average molecular weight (Mn) of the polyalkylene imine employed in step lies in the range of 200 to 10 000 g/mol, more preferably in the range of 400 to 6 000 g/mol, most preferably 600 to 3000 g/mol.

### EMBODIMENT 10

The modified alkoxylated polyalkylene imine or modified alkoxylated polyamine according to any of Embodiments 1 to 9, wherein
i) in step a) the first lactone (LA1) is caprolactone or lactide, and/or
ii) in step a) the first hydroxy carbon acid (HA1) is lactic acid or glycolic acid, and/or
iii) in step b) (i) and (ii) the first alkylene oxide (AO1) is ethylene oxide or a mixture of ethylene oxide and propylene oxide or a mixture of ethylene oxide and butylene oxide, and/or in step b) (ii) the second lactone (LA2) is caprolactone or lactide, and/or the second hydroxy carbon acid (HA2) is lactic acid or glycolic acid, and/or
iv) in step c) (i) and (ii) the second alkylene oxide (AO2) is propylene oxide or a mixture of propylene oxide and ethylene oxide or a mixture of propylene oxide and butylene oxide, and/or in step c) (ii) the third lactone (LA3) is caprolactone or lactide, and/or the third hydroxy carbon acid (HA3) is lactic acid or glycolic acid, and/or
v) in step d) the fourth lactone (LA4) is caprolactone or lactide, and/or
vi) in step d) the fourth hydroxy carbon acid (HA4) is lactic acid or glycolic acid.

The polymers of the invention comprise side chains which are attached to nitrogen atoms of said polymer (modified alkoxy chains). The side chains are made up from lactones and/or hydroxy carbon acids and C2-C22-alkylene oxides. Typically, a side chain comprises at least one lactone (LA) and/or at least one hydroxy acid (HA) and at least one alkylene oxide (AO). The reaction to prepare a side chain comprising LA and/or HA and AO is—by way of example for the preparation of the side chains in general—typically done by reacting a polyalkylene imine or polyamine with the at least one LA and/or HA (in an amount of at least 2 mol LA and/or HA per mol NH-functionality) by adding first the LA1 or the HA1 to the polyalkylene imine or polyamine. Subsequently, AO1 or a mixture of AO1 and LA2 and/or HA2 is added. Then, optionally AO2 or a mixture of AO2 and LA3 and/or HA3 is added. In any case, at least one mixture of at least one alkylene oxide (AO1, AO2) with 2) at least one lactone (LA2, LA3) and/or at least one hydroxy carbon acid (HA2, HA3) is applied in at least one of those two last-mentioned steps. In the following step optionally LA4 and/or HA4 is added, and in the final step optionally the C1-C18 alkylation or esterification reagent is added.

By adding the monomers in a stepwise manner, according to steps a) to e) of the inventive process and as described above, block structures are being formed.

Furthermore, in terms of steps b) and c), since mixtures of AO and LA and/or HA are employed in at least one of those steps, additional random copolymer sequences within the block copolymer chains are being formed that are attached to the nitrogen atoms of the backbone.

Preferably, a side chain comprises more than 5, more preferably more than 10, even more preferably more than 15 AO units per NH-functionality of the inventive polymer. In addition, the side chain comprises at least 3 units LA and/or HA per NH-functionality. All such numbers are numbers “on average” meaning that such numbers refer to the average number for such unit per NH-functionality calculated based on all NH-functionalities of a polyalkylene imine or polyamine. Additionally, it has to be noted within the context of the process according to the present invention that those primary amino moieties of the respective backbone, which are reacted first with at least one lactone and/or at least one hydroxy carbon acid are transferred into an amido moiety wherein one of the originally two hydrogen atoms of the respective primary amino moiety is replaced by a fragment originating from the respective lactone or hydroxy carbon acid, whereas the second hydrogen atom of the primary amino moiety of the backbone does not get substituted by this reaction. Beyond that, such a second hydrogen atom of the primary amino moiety of the backbone does also not become substituted within the further reaction steps, e.g., further reactions with AO, LA and/or HA.

It is to be emphasized that the reactions leading to the inventive polymers are statistical reactions, meaning there is never just one chemically exactly defined compound present, but an inventive polymer always is a mixture of slightly deviating structures, all stemming from the same reaction within one reaction space; the difference of those structures clearly stemming from the facts that no reaction proceeds in exactly the same way and the same speed on all functional units, especially as the chemical reactivities of the functional units—here mainly those of the NH-functionalities, differs according to their environment, meaning that a primary amino group reacts differently than a secondary amine (specifically in terms of reaction with a lactone and/or a hydroxy carbon acid, as described above), and also the chemical environment of the groups may be different in the monomers employed; this leads in an overall view to slightly deviating structures being present, and thus any polymer of this invention being defined as in the various embodiments including the numbered Embodiments 1 to 31, and exemplified in the examples never is just one chemical compound, but always a mixture of slightly deviating compounds, having a statistical distribution. As the reactivities of those groups are not differing by a large extent, the deviation is relatively small. Hence, defining a polymer of the invention by their monomers is a viable way of defining the structures. Also, defining the composition of the side chains by average numbers (including those variables defined in the present and following Embodiments based on the numbers of NH-functionalities being present in the polyalkylene imine or polyamine—such number of functionalities being themselves an average number due to this factual mixture—is a useful way of defining the overall composition of any mixture herein defined as “a modified alkoxylated polyalkylene imine or modified alkoxylated polyamine of the invention”.

Therefore, unless otherwise indicated, the values, ranges and ratios given in the specification for the number of NH-functionalities and the molecular weight (Mn) relate to the number average values in case a polymeric mixture (polyalkylene imines or polyamines) and not a defined organic polyamine starting material is employed in step a) of the present invention, as the inventive polymers contain individual, slightly from each other deviating chemical structures of several polymer-compounds, with “the polyalkylene imine or polyamine” defining this mixture being the result from the preparation method. As known in polymer science, the weight-average molecular weight (Mw) is then a measure for the (in) homogeneity within the mixture of different species in “the polyalkylene imine or polyamine”.

For the sake of completeness, it is indicated that the weight average molecular weight (Mw) is identical to the number average molecular weight (Mn) in case that defined (pure) organic polyamines are employed as starting materials in step a) of the inventive process. Therefore, Mw and Mn are identical to their molar mass for those cases.

Suitable lactones and/or hydroxy carbon acids can be aliphatic, cycloaliphatic or aromatic. Particularly suitable aromatic hydroxy carbon acids are hydroxy-substituted benzoic acids and naphthalene carboxylic acids, such as p-hydroxyethyl benzoic acid and 2-hydroxynaphthalene-6-carboxylic acid. Preference is given to aliphatic hydroxy carbon acids, especially to those with hydroxyl groups in the w position, and their lactones. In general, the aliphatic hydroxy carbon acids have from 1 to 22 alkylene radicals, preferably from 2 to 10 alkylene radicals, more preferably from 2 to 5 alkylene radicals. The alkylene radicals may be linear or branched. Examples which may be mentioned are glycolic acid, lactic acid and its lactide, gamma-hydroxybutyric acid and gamma-butyrolactone, delta-hydroxyvaleric acid and gamma- and delta-valerolactone, epsilon-hydroxycaproic acid and epsilon-caprolactone, 12-hydroxystearic acid and ricinoleic acid, and also mixtures, especially including naturally occurring acids. Preferably, glycolic acid, lactic acid, epsilon-caprolactone or lactide, or mixtures thereof, are employed, even more preferably epsilon-caprolactone.

For clarifications of this Embodiment, LA1, LA2, LA3 and LA4 may be identical or different from each other.

For clarifications of this Embodiment, HA1, HA2, HA3 and HA4 may be identical or different from each other.

### EMBODIMENT 11

The modified alkoxylated polyalkylene imine or modified alkoxylated polyamine according to any of Embodiments 1 to 10, wherein
i) in steps b) (i), b) (ii), c) (i) and/or c) (ii) in total 5 to 100 mol, preferably 10 to 80 mol, more preferably 12 to 60 mol, most preferably 15 to 40 mol alkylene oxide (AO1 and/or AO2) is employed per mol of NH-functionality of polyalkylene imine or polyamine, wherein more than 70 mol %, preferably more than 90 mol % of the alkylene oxide is based on ethylene oxide, and/or
ii) in steps a), b) (ii), c) (ii) and/or d) in total 2 to 10 mol, preferably 3 to 7 mol, more preferably 3 to 6 mol of lactone (LA1, LA2, LA3 and/or LA4) and/or 3 to 20 mol, preferably 3 to 15 mol, more preferably 3 to 10 mol of hydroxy carbon acid (HA1, HA2, HA3 and/or HA4) is employed per mol of NH-functionality of polyalkylene imine or polyamine.

It is noted that the alkylene oxide used to prepare the inventive polymer may be derived from a fossil or non-fossil carbon source or even a mixture of the before mentioned. Preferably, the amount of non-fossil carbon atoms in the alkoxy side chains is at least 10%, at least 20%, at least 40%, at least 70%, at least 95% or it solely comprises non-fossil derived carbon atoms. The skilled person is well-aware of commercial alkylene oxide products made of non-fossil carbon sources (these products are often sold as being sustainable, renewable or bio-based). For example, Croda International, Snaith, UK, sells ethylene oxide and related products based on bio-ethanol as ECO Range. Additionally, methods to prepare bio-based propylene oxide are also known (see Abraham, D. S., “Production of propylene oxide from propylene glycol” Master's Thesis University of Missouri-Columbia (2007) (75 pages)).

### EMBODIMENT 12

The modified alkoxylated polyalkylene imine or modified alkoxylated polyamine according to any of Embodiments 1 to 11, wherein
i) in steps b) (i), b) (ii), c) (i) and/or c) (ii)) in total 25 to 120 mol, preferably 30 to 100 mol, more preferably 35 to 90 mol, most preferably 40 to 80 mol of alkylene oxide (AO1 and/or AO2) is employed per mol of NH-functionality of polyalkylene imine or polyamine, whereas less than 70 mol %, preferably less than 60 mol % of the alkylene oxide is based on ethylene oxide,
ii) in steps a), b) (ii), c) (ii) and/or d) in total 2 to 10 mol, preferably 3 to 8 mol, more preferably 3 to 7 mol of lactone (LA1, LA2, LA3 and/or LA4) and/or 3 to 20 mol, preferably 3 to 15 mol, more preferably 3 to 10 mol of hydroxy carbon acid (HA1, HA2, HA3 and/or HA4) is employed per mol of NH-functionality of polyalkylene imine or polyamine.

### EMBODIMENT 13

The modified alkoxylated polyalkylene imine or modified alkoxylated polyamine according to any of Embodiments 1 to 12, wherein
(1) in step a) the at least one polyalkylene imine is polyethylene imine with a weight average molecular weight (Mw) ranging from 500 g/mol to 1000 g/mol, wherein 1 to 5 mol of caprolactone is employed per mol of NH-functionality of polyalkylene imine; and in step b) (ii) a mixture of 15 to 40 mol of ethylene oxide and 1 to 3 mol of caprolactone is employed per mol of NH-functionality of polyalkylene imine, wherein in total at least 2 mol of caprolactone is employed per mol of NH-functionality polyalkylene imine; or
(2) in step a) the at least one polyalkylene imine is polyethylene imine with a weight average molecular weight (Mw) ranging from 1500 g/mol to 2500 g/mol, wherein 1 to 5 mol of caprolactone is employed per mol of NH-functionality of polyalkylene imine; and in step b) (i) 15 to 40 mol of ethylene oxide is employed per mol of NH-functionality of polyalkylene imine; and in step c) (ii) a mixture of 15 to 40 mol of propylene oxide and 1 to 3 mol of caprolactone is employed per mol of NH-functionality of polyalkylene imine; wherein the molar ratio of ethylene oxide to propylene oxide ranges from 1.5:1 to 1:1.5 and wherein in total at least 2 mol of caprolactone is employed per mol of NH-functionality polyalkylene imine; or
(3) in step a) the at least one polyalkylene imine is polyethylene imine with a weight average molecular weight (Mw) ranging from 4000 g/mol to 6000 g/mol, wherein 1 to 5 mol of caprolactone is employed per mol of NH-functionality of polyalkylene imine; and in step b) (i) 15 to 40 mol of ethylene oxide is employed per mol of NH-functionality of polyalkylene imine; and in step c) (ii) a mixture of 15 to 40 mol of propylene oxide and 1 to 3 mol of caprolactone is employed per mol of NH-functionality of polyalkylene imine; wherein the molar ratio of ethylene oxide to propylene oxide ranges from 1.5:1 to 1:1.5, wherein in total at least 2 mol of caprolactone is employed per mol of NH-functionality polyalkylene imine.

### EMBODIMENT 14

The modified alkoxylated polyalkylene imine or modified alkoxylated polyamine according to any of Embodiments 10 to 13, wherein at least 50%, preferably at least 60% and most preferably at least 80%, even more preferably at least 90, and most preferably at least 95% of all side chains attached to the NH-functionalities of one specific modified alkoxylated polyalkylene imine or modified alkoxylated polyamine have the same structural order, in that sense that the structural order is defined by the order of the given alkylene oxides, lactones and/or hydroxy carbonic acids employed during the stepwise synthesis of the polymer of the invention.

Without wishing being bound by the following explanation, a rationale exists to explain the resulting structures of the modified alkoxylated polyalkylene imines or modified alkoxylated polyamines: Due to the fact that the reactions in questions necessarily employed to prepare those structural orders of the side chains, and thus to prepare the specific inventive polymers, are reactions of quite reactive species which can lead under suitable conditions to almost complete and even “essentially complete” conversions of almost 100% if not even 100%, for each step of the inventive process, the statistical deviation of the composition of the mixture of “the modified alkoxylated polyalkylene imines or modified alkoxylated polyamines” in question is not that high, which in turn means that the structural order of the side chains do not show much deviation. Thus, it is a reliable assumption which can in principle be proven by sophisticated and thus time-consuming and expensive analytical means—such as multi-dimensional NMR-analyses—that it is generally accepted that such deviation exists; hence, no “specific modified alkoxylated polyalkylene imine or modified alkoxylated polyamine” will be “just one chemical compound of a clearly defined chemical structure”, but clearly will consist of a a) mixture of slightly differing compounds, such differences lying in b) potentially slight deviations already in the structure of compound making up “the (unmodified) polyalkylene imine or polyamine” being employed for the further modification steps, as described above, and c) the slight deviations in the structural orders of the side chains attached by way of d) multi-step reactions due to e) variations in the chemical reactivities of the NH- and subsequently formed OH-functionalities, f) slight differences in the reactivities of employed AO, LA and HA due to their structure and g) due to their reactivities towards the slightly differing reactivities NH- and subsequently formed OH-functionalities, and h) due to slight inhomogeneities occurring in a commercial scale process. All of those factors a) to h)—to just mention a few important ones—lead to a “specific modified alkoxylated polyalkylene imine or modified alkoxylated polyamine” which is not one specific chemical compound but in fact a mixture of slightly differing compounds having an overall very similar chemical structure; thus, such structure is best described by average numbers for the variables and percentages for the amounts of the dominating structural order.

Furthermore, experimental evidence created by the inventors, but not included in the Example part of this description suggests that a trans-esterification reaction of the lactone and/or hydroxy carbon acid derived part may occur within the alkoxy side chain. This reaction was solely observed for lactones and/or hydroxy carbon acids that reacted with each other and/or with AO to form ester bonds, but not for those that were directly attached to the NH-functionality of the polyalkylene imine to form amide bonds. The trans-esterification reaction was observed in cases where a prior reaction of lactones and/or hydroxy carbon acids with each other and/or with AO to form ester bonds was followed by a later reaction with alkylene oxides, such as ethylene oxide and/or propylene oxide. Such observation appears consistent with the fact that the reaction with the alkylene oxides is carried out under high pressure, high temperature and furthermore strong alkaline conditions. Such trans-esterification will be, in addition to the previous parameters, another factor that provides uncertainty to the final structure of the inventive polymers.

### EMBODIMENT 15

The modified alkoxylated polyalkylene imine or modified alkoxylated polyamine according to any of Embodiments 1 to 14, which is further modified by quaternization using standard means, including protonation by pH-adjustment or permanent quaternization by standard means such as alkylation using standard reactants, preferably by alkylation, to a degree of from 5 to 100, preferably of from 5 to 95, more preferably of from 50 to 95, even more preferably of from 75 to 95 percent of all nitrogen-atoms within the inventive polymer.

It is well-known to a person of skill in the art that alkoxylated polyalkylene imine or alkoxylated polyamine structures in general can be quaternized using standards means, due to their in principle chemical similarity with already known structures of this general type, and the known ability to modify those known structures by quaternization.

Clearly, also the present structures described herein as modified alkoxylated polyalkylene imines or modified alkoxylated polyamines can be quaternized as well.

A suitable degree of quaternization is up to 100%, in particular from 5 to 95%. The quaternization is conducted preferably by introducing C1-C22-alkyl groups, C1-C4-alkyl groups and/or C7-C22-aralkyl groups and may be undertaken in a customary manner by reaction with corresponding alkyl halides and dialkyl sulfates.

The quaternization may be advantageous in order to adjust the inventive polymer to the particular composition such as laundry compositions in which they are to be used, and to achieve better compatibility and/or phase stability of the formulation.

The quaternization of the inventive polymer is achieved preferably by introducing C1-C22 alkyl, C1-C4-alkyl groups and/or C7-C22 aralkyl, aryl or alkylaryl groups and may be undertaken in a customary manner by reaction with corresponding alkyl-, aralkyl-halides and dialkylsulfates, as described for example in WO 09/060059.

Quaternization can be accomplished, for example, by reacting an inventive polymer with an alkylation agent such as a C1-C4-alkyl halide, for example with methyl bromide, methyl chloride, ethyl chloride, methyl iodide, n-butyl bromide, isopropyl bromide, or with an aralkyl halide, for example with benzyl chloride, benzyl bromide or with a di-C1-C22-alkyl sulfate in the presence of a base, especially with dimethyl sulfate or with diethyl sulfate. Suitable bases are, for example, sodium hydroxide and potassium hydroxide.

The amount of alkylating agent determines the amount of quaternization of the amino groups in the polymer, i.e., the amount of quaternized moieties.

The amount of the quaternized moieties can be calculated from the difference of the amine number in the non-quaternized amine and the quaternized amine. The amine number can be determined according to the method described in DIN 16945.

The quaternization can be carried out without any solvent. However, a solvent or diluent like water, acetonitrile, dimethylsulfoxide, N-methylpyrrolidone, etc. may be used. The reaction temperature is usually in the range from 10° C. to 150° C. and is preferably from 50° C. to 100° C.

The quaternization may be advantageous in order to adjust the modified alkoxylated polyalkylene imine or modified alkoxylated polyamine to the particular composition such as laundry compositions in which they are to be used, and to achieve better compatibility and/or phase stability of the formulation

### EMBODIMENT 16

A process to prepare a modified alkoxylated polyalkylene imine or modified alkoxylated polyamine according to any one of Embodiments 1 to 15 comprising carrying out the process steps according to any one of Embodiments 1 to 15.

In particular, the process comprises the following steps:
a) reaction of 1) at least one polyalkylene imine or at least one polyamine comprising in total a plurality of primary and secondary amino groups with 2) at least one first lactone (LA1) and/or at least one first hydroxy carbon acid (HA1), wherein 1 to 10 mol of lactone (LA1) and/or of hydroxy carbon acid (HA1) is employed per mol of NH-functionality of polyalkylene imine or polyamine, in order to obtain a first intermediate (I1),
b) reaction of the first intermediate (I1) (i) with at least one first alkylene oxide (AO1) or (ii) with a mixture of 1) at least one first alkylene oxide (AO1) with 2) at least one second lactone (LA2) and/or at least one second hydroxy carbon acid (HA2), wherein at least 5.0 mol of first alkylene oxide (AO1) and for the mixture additionally at least 1.0 mol of second lactone (LA2) and/or second hydroxy carbon acid (HA2) is employed per mol of NH-functionality of polyalkylene imine or polyamine, as employed in step a), in order to obtain a second intermediate (I2),
c) optionally reaction of the second intermediate (I2) (i) with at least one second alkylene oxide (AO2) or (ii) with a mixture of 1) at least one second alkylene oxide (AO2) with 2) at least one third lactone (LA3) and/or at least one third hydroxy carbon acid (HA3), wherein at least 5.0 mol of second alkylene oxide (AO2) and for the mixture additionally at least 1.0 mol of third lactone (LA3) and/or third hydroxy carbon acid (HA3) is employed per mol of NH-functionality of polyalkylene imine or polyamine, as employed in step a), in order to obtain a third intermediate (I3),
d) optionally reaction of the second intermediate (I2) or third intermediate (I3) with at least one fourth lactone (LA4) and/or at least one fourth hydroxy carbon acid (HA4), wherein at least 1.0 mol of fourth lactone (LA4) and/or fourth hydroxy carbon acid (HA4) is employed per mol of NH-functionality of polyalkylene imine or polyamine, as employed in step a), in order to obtain a fourth intermediate (I4),
e) optionally reaction of the second intermediate (I2), third intermediate (I3) or fourth intermediate (I4) with at least one C1-C₁₈ alkylation or esterification reagent, in order to obtain the modified alkoxylated polyalkylene imine or the modified alkoxylated polyamine,
wherein the amount of second, third and/or fourth lactones and/or the amount of second, third and/or fourth hydroxy carbon acids is at least 1 mol per mol of NH-functionality of polyalkylene imine or polyamine, as employed in step a), and
wherein the total amount of first, second, third and/or fourth lactones and/or the total amount of first, second, third and/or fourth hydroxy carbon acids is at least 2 mol per mol of NH-functionality of polyalkylene imine or polyamine, as employed in step a), and
wherein
(i) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located terminally, and/or
(ii) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located adjacent to each other,
wherein a mixture of 1) at least one alkylene oxide (AO1, AO2) with 2) at least one lactone (LA2, LA3) and/or at least one hydroxy carbon acid (HA2, HA3) is applied in at least one of the steps b) and/or c).

All of the terms within Embodiment 16 have already been defined and explained in detail herein before within the description of the Embodiments 1 to 15, such terms and definitions of course apply to this Embodiment 16.

The conversion rate of each reaction step may be monitored: Only when the previous reaction has proceeded to a conversion rate of at least 90%, preferably at least 95%, more preferably at least 99%, and even more preferably at least 99.5% or even more has been achieved, the next reactant may be added which in turn is also monitored for its conversion rate to detect when this next reaction has proceeded to a conversion rate of at least 90%, preferably at least 95%, more preferably at least 99%, and even more preferably at least 99.5% or even more has been achieved, then the even next reaction is to be added—and so on until all reactants have been reacted and the reaction of the last reactant added has proceeded to a conversion rate of at least 90%, preferably at least 95%, more preferably at least 99%, and even more preferably at least 99.5% or even more has been achieved. All other structural orders of the side chains as defined above but also the undefined structures resulting from non-controllable parameters are performed in this defined manner, leading—on statistical average—to a defined structural order directly derived from the way such a stepwise reaction is performed.

The conversion rate of each of the respective steps can be determined according to methods known to the skilled person, such as NMR-spectroscopy, such as 13C-NMR-spectroscopy and/or 1H NMR-spectroscopy.

For the reaction conditions such as catalysts, temperatures, duration, purification etc. of the reactions to produce the units of the side chains of the inventive modified alkoxylated polyalkylene imines or modified alkoxylated polyamines, the respective information within the disclosures WO 2021/165468 and unpublished patent applications EP 21176904.7, EP 21176906.2, EP 21192170.5 and EP 21192169.7 is fully encompassed into this recent disclosure by way of reference.

The reaction of the polyalkylene imine or polyamine or intermediates 11 to 13 with LA or HA and the reaction of any of the intermediates with AO can be carried out without any catalyst or in the presence of any catalyst which aids deprotonation of the amino group or the hydroxy group, such as potassium hydroxide, potassium methoxide or potassium tert·butylhydroxide to name only very few. Preferred catalysts for reacting the polyalkylene imine or polyamine or intermediates I1 to I3 with LA or HA are selected from Sn-octanoate and from alkali metal hydroxides or alkali metal alkoxides, such as KOH, NaOH, KOMe, KOtBu or NaOMe.

Within this preferred Embodiment, the alkoxylation is carried out in the presence of at least one catalyst. Within this single step reaction of the alkoxylation step, the catalyst is preferably a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, a particular preference being given to potassium hydroxide and sodium hydroxide. Typical use amounts for the base are from 0.05 to 10% by weight, in particular from 0.2 to 2% by weight, based on the total amount of polyalkylene imine or polyamine, lactone and/or hydroxy carbon acid and alkylene oxide.

### EMBODIMENT 17

Process according to Embodiment 16, wherein the modified alkoxylated polyalkylene imine or modified alkoxylated polyamine is further submitted to the following process steps of
a) quaternization using standard means, including protonation by pH-adjustment or permanent quaternization by standard means such as alkylation using standard reactants, preferably by alkylation, to a degree of from 5 to 100, preferably of from 5 to 95, more preferably of from 50 to 95, even more preferably of from 75 to 95 percent of all nitrogen-atoms within the polyalkylene imine or polyamine; and/or
b) purification using standard means such as steam distillation, thermal distillation, vacuum evaporation, including removal of all solvent, dialysis and/or
c) drying using standard drying means such as spray-, drum, paddle-, vacuum-drying means including agglomeration methods such as fluidized-bed-drying,
   to obtain a purified (quaternized) polymer solution, a purified liquid (quaternized) polymer, a solid, e.g., granulated or co-granulated (quaternized) polymer or a purified solid (quaternized) polymer, respectively.

In case that after the reaction leading to the inventive polymer residual monomers are present to a non-desirable extent, the resulting product mixture containing the modified alkoxylated polyalkylene imine or modified alkoxylated polyamine may be further purified by standard means to reduce the content of residual monomers, but also to reduce the amount of possible by-products, reduce the amount(s) of the solvent(s) employed (i.e., to concentrate) or replace solvent(s) with other solvents. Such processes are known to a person of skill in this field.

Preferably, undesirable amounts of residual non-reacted monomers are removed, preferably by means of distillative processes, more preferably by thermal distillative processes, which may additionally comprise the application of reduced pressure to increase the speed and/or the effectiveness of the removal.

In a preferred embodiment only the additional process step b) is employed.

### Use of and Compositions Comprising the Inventive Modified Alkoxylated Polyalkylene Imines or Modified Alkoxylated Polyamines

Part of this invention is also the use of the inventive modified alkoxylated polyalkylene imines or modified alkoxylated polyamines for various fields of applications, where they can replace currently known similar structures, but bring in their enhanced rate of biodegradation compared to those previously known structures.

### EMBODIMENT 18

Use of at least one modified alkoxylated polyalkylene imine or modified alkoxylated polyamine according to any one of Embodiments 1 to 17 in cleaning compositions, in fabric and home care products, in cosmetic formulations, as crude oil emulsion breaker, in pigment dispersions for ink jet inks, in formulations for electro plating, in cementitious compositions, as dispersant for agrochemical formulations.

A subject matter of the present invention is the use of the above-mentioned modified alkoxylated polyalkylene imine or modified alkoxylated polyamine in fabric and home care products, in cosmetic formulations, as crude oil emulsion breaker, in pigment dispersions for ink jet inks, in formulations for electro plating, in cementitious compositions and/or as dispersant for agrochemical formulations, preferably in cleaning compositions and/or in fabric and home care products, in particular cleaning compositions for improved clay removal or oily and fatty stain removal, wherein the cleaning composition is preferably a laundry detergent formulation and/or a manual dish wash detergent formulation, more preferably a liquid laundry detergent formulation and/or a liquid manual dish wash detergent formulation.

The modified alkoxylated polyalkylene imine or modified alkoxylated polyamine can be added to cosmetic formulations, as crude oil emulsion breaker, in pigment dispersions for ink jet inks, formulations for electro plating, in cementitious compositions. However, the inventive compounds can also be added to (used in) washing or cleaning compositions.

Another subject-matter of the present invention is, therefore, a cleaning composition, fabric and home care product, industrial and institutional cleaning product, cosmetic formulation, crude oil emulsion breaker, pigment dispersion for ink jet inks, formulation for electro plating, cementitious composition and/or dispersant for agrochemical formulations, comprising at least one modified alkoxylated polyalkylene imine or modified alkoxylated polyamine, as defined above. Preferably, it is a cleaning composition and/or fabric and home care product, comprising at least one modified alkoxylated polyalkylene imine or modified alkoxylated polyamine, as defined above, preferably for improved clay removal or oily and fatty stain removal, preferably a laundry detergent formulation and/or a manual dish wash detergent formulation, more preferably a liquid laundry detergent formulation and/or a liquid manual dish wash detergent formulation.

In another preferred embodiment of the present invention, the cleaning composition may be used for soil removal of particulate stains and/or oily and fatty stains, and additionally for whiteness maintenance, preferably in laundry care.

In another embodiment, the cleaning composition of the present invention is a hard surface cleaning composition that may be used for cleaning various surfaces such as hard wood, tile, ceramic, plastic, leather, metal, glass.

In another embodiment, the cleaning composition of the present invention is a liquid or solid automatic dish wash detergent composition, preferably a solid automatic dish wash detergent composition, that may be used for cleaning dish ware, e.g., dish ware such as glasses, wherein the inventive modified alkoxylated polyalkylene imine or modified alkoxylated polyamine is improving the removal of stubborn soils.

In another embodiment, the cleaning composition is designed to be used in personal care and pet care compositions such as shampoo compositions, body wash formulations, liquid or solid soaps.

In this invention, a preferred area of application for the use of the modified alkoxylated polyalkylene imine or modified alkoxylated polyamine is the field of fabric and home care products and cleaning compositions, preferably cleaning compositions for industrial and institutional use and the use by consumers in their household.

### EMBODIMENT 19

The use according to Embodiment 18 in cleaning compositions and/or in fabric and home care products, preferably in liquid and solid detergent compositions, such detergent compositions preferably being
a) manual and automatic dish wash detergent compositions, comprising the at least one modified alkoxylated polyalkylene imine or modified alkoxylated polyamine, and the at least one chelating agent and/or the at least one surfactant or—more preferably—a chelating agent in case of a liquid or solid automatic dish wash composition and a surfactant system in case of a liquid manual dish wash detergent composition, respectively; and/or
b) laundry detergent compositions comprising the at least one modified alkoxylated polyalkylene imine or modified alkoxylated polyamine, and at least one surfactant or—preferably—a surfactant system.

Within such preferred application areas of use, typical tasks have to be fulfilled, all of which are commonly encompassed by the term “cleaning”, but in fact comprise different tasks such as clay removal or removing oily and fatty residues, solid residues, amphiphilic residues and hydrophilic residues. Other tasks are the protection of the goods to be cleaned from deterioration, such as protecting glass from corroding, silverware from oxidation, colors from fading etc. Other tasks are improving the overall appearance of the to be cleaned goods, such as increasing or restoring the color, the whiteness, imparting or increasing a shine. For many such applications additional ingredients are typically added, for cleaning applications important ones are for example enzymes, which help biologically to degrade residues.

### EMBODIMENT 20

The use according to any of Embodiments 18 to 19 for
i) clay removal, and/or
ii) improved removal of oily/fatty stains, and/or
iii) soil removal of particulate stains, and/or
iv) dispersion and/or emulsification of soils, and/or
v) modification of treated surface to improve removal upon later re-soiling, and/or
vi) whiteness improvement, and/or
vii)—when at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, more preferably at least one enzyme being selected from proteases, is present—additionally for improvement of removal of oily/fatty stains, food stain removal and/or removal of complex stains,
most preferably in cleaning compositions for
i) clay removal and/or ii) removal of oily/fatty stains,
each of the before mentioned options i) to vii) preferably for use in a laundry detergent formulation and/or a manual dish wash detergent formulation and/or in a formulation suitable for (pre)-treatment of textiles and/or soap bars, more preferably in a liquid laundry detergent formulation and/or a liquid manual dish wash detergent formulation.

### EMBODIMENT 21

The use according to any of Embodiments 18 to 20 in cleaning compositions and/or in fabric and home care products, preferably in cleaning compositions for fabric and home care, the cleaning composition preferably being a laundry detergent formulation or a dish wash detergent formulation, even more preferably being a liquid laundry detergent formulation or a liquid dish wash detergent formulation.

Such ingredients are typically formulated with other ingredients in formulations and compositions, which may be also called “products” (as they are provided from a supplier as a formulation to another customer who uses such formulation directly for cleaning purposes etc. or for producing another formulation, which in turn could be sold to consumers as a “product” to be used by the consumer).

### EMBODIMENT 22

A composition that is a fabric and home care product, cleaning composition, industrial and institutional cleaning product, cosmetic or personal care product, oil field-formulation such as crude oil emulsion breaker, pigment dispersion for inks such as ink-jet inks, electro plating product, cementitious composition, lacquer, paint, agrochemical formulation, preferably a laundry detergent, a dish wash composition, a cleaning composition and/or a fabric and home care product, each comprising at least one modified alkoxylated polyalkylene imine or modified alkoxylated polyamine according to any of the Embodiments 1 to 15 or obtained by or obtainable by a process according to any of Embodiments 16-17.

### EMBODIMENT 23

A composition according to Embodiment 22 being a solid or liquid laundry detergent composition or a solid or liquid manual dish wash detergent composition, preferably a liquid laundry detergent or a liquid manual dish wash detergent composition, more preferably a liquid laundry detergent composition, comprising the least one modified alkoxylated polyalkylene imine or modified alkoxylated polyamine according to any one of Embodiments 1 to 15 or obtained by or obtainable by a process according to any of Embodiments 16-17;
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases, optionally containing at least one antimicrobial agent,
wherein the at least one modified alkoxylated polyalkylene imine or modified alkoxylated polyamine is present in an amount ranging from about 0.01% to about 20%, preferably from about 0.05% to 15%, more preferably from about 0.1% to about 10%, and most preferably from about 0.5% to about 5%, in relation to the total weight of such composition or product, and
such product or composition further comprising from about 1% to about 70% by weight of at least one surfactant, preferably an anionic surfactant, or even more preferably of a surfactant system comprising at least one anionic surfactant.

### EMBODIMENT 24

A composition according to Embodiment 22 being a solid or liquid automatic dish wash detergent composition, preferably a solid automatic dish wash detergent composition, comprising the at least one modified alkoxylated polyalkylene imine or modified alkoxylated polyamine according to any one of Embodiments 1 to 15 or obtained by or obtainable by a process according to any of Embodiments 16-17;
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases and amylases,
optionally containing at least one antimicrobial agent,
optionally containing at least one compound selected from alkali metal percarbonate, alkali metal perborate and alkali metal persulfate,
optionally containing at least one zinc salt,
wherein the at least one modified alkoxylated polyalkylene imine or modified alkoxylated polyamine is being present in a total amount ranging from about 0.001% to about 10%, preferably from about 0.005% to 5%, more preferably from about 0.01% to about 3%, and most preferably from about 0.1% to about 2%, and such product or composition further comprising at least one chelating agent being present in a total amount from about 1% to about 70%, preferably from 10% to about 60% and even more preferably from 30% to about 50%, and
optionally further comprising at least one surfactant or more preferably a surfactant system in a total amount of from about 1% to about 70% by weight,
all weight percent in relation to the total weight of such composition.

### EMBODIMENT 24A

A composition according to Embodiment 24, being a solid automatic dish wash detergent composition, comprising the at least one modified alkoxylated polyalkylene imine or modified alkoxylated polyamine according to any one of Embodiments 1 to 15 or obtained by or obtainable by a process according to any of Embodiments 16-17, and
additionally comprising at least one chelating agent selected from methylglycinediacetic acid (MGDA), glutamic acid diacetate (GLDA), citric acid and salts thereof,
at least one enzyme selected from proteases and/or amylases,
at least one bleaching agent selected from alkali metal percarbonate, alkali metal perborate and alkali metal persulfate, preferably alkali metal percarbonate,
at least one non-ionic surfactant,
optionally at least one disintegrant, preferably a super-disintegrant, more preferably PVPP, and
optionally containing at least one zinc salt.

Super-disintegrants are known by a person of skill in the art, e.g. from EP1004661, EP1263814 and EP1036839, and are discussed also in Pharmaceutical Technology, Volume 2006 Supplement, Issue 5, “A Comparative Study of Current Superdisintegrants”, Oct. 1, 2006.

### EMBODIMENT 25

Composition according to any of Embodiments 22 and 23 being a detergent composition, comprising as surfactant at least one anionic surfactant.

### EMBODIMENT 26

Composition according to any of Embodiments 22 and 23 being a liquid detergent composition, comprising as surfactant at least one non-ionic surfactant, and further comprising water.

### EMBODIMENT 27

Composition according to any of Embodiments 22, 23, 25 and 26 being a detergent composition, comprising at least one further polymer selected from multifunctional alkoxylated polyethylene imines, multifunctional alkoxylated diamines or terephthalic acid-based soil release polyesters, or mixtures thereof.

### EMBODIMENT 28

Composition according to any of Embodiments 22, 23 and 25 to 27 being a liquid detergent composition, comprising as surfactant at least one 2-propylheptyl ethoxylated non-ionic surfactant having an average degree of ethoxylation of from 3 to 8.

### EMBODIMENT 29

Composition according to any one of Embodiments 22 to 28 further comprising an antimicrobial agent selected from the group consisting of 2-phenoxyethanol and 4,4′-dichloro 2-hydroxydiphenylether; preferably comprising 2-phenoxyethanol in an amount ranging from 2 ppm to 5% by weight of the composition; more preferably comprising 0.1 to 2% of phenoxyethanol or preferably comprising 4,4′-dichloro 2-hydroxydiphenylether in a concentration from 0.001 to 3%, more preferably 0.002 to 1%, even more preferably 0.01 to 0.6%, each by weight of the composition.

### EMBODIMENT 30

Composition according to any one of Embodiments 22 to 29 further comprising at least one enzyme selected from the list consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types, preferably selected from one or more lipases, hydrolases, amylases, proteases, cellulases, and combinations of at least two of the foregoing types, more preferably at least one enzyme being selected from proteases.

### EMBODIMENT 31

Method of preserving an aqueous composition according to any one of Embodiments 22 to 30 against microbial contamination or growth, which method comprises addition of an antimicrobial agent selected from the group consisting of 2-phenoxyethanol and 4,4′-dichloro 2-hydroxydiphenylether.

It is also preferred in the present invention that the cleaning composition comprises (besides at least one modified alkoxylated polyalkylene imine or modified alkoxylated polyamine as described above) additionally at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, preferably selected from one or more lipases, hydrolases, amylases, proteases, cellulases and combinations of at least two of the foregoing types, more preferably at least one enzyme being selected from proteases.

Preferably, the such inventive cleaning composition is a fabric and home care product or an industrial and institutional (I&I) cleaning product, preferably a fabric and home care product, more preferably a laundry detergent or manual dish washing detergent, comprising at least one inventive modified alkoxylated polyalkylene imine or modified alkoxylated polyamine, and optionally further comprising at least one surfactant or a surfactant system, providing improved removal, dispersion and/or emulsification of soils and/or modification of treated surfaces and/or whiteness maintenance of treated surfaces.

At least one inventive modified alkoxylated polyalkylene imine or modified alkoxylated polyamine as described herein (such modified alkoxylated polyalkylene imine or modified alkoxylated polyamine as defined before and especially in the Embodiments 1 to 15 are in this following section also termed “inventive polymer”) is present in said inventive cleaning compositions at a concentration of from about 0.01% to about 20%, preferably from about 0.05% to 15%, more preferably from about 0.1% to about 10%, and most preferably from about 0.5% to about 5%, in relation to the total weight of such composition or product; such cleaning composition may—and preferably does—further comprise a from about 1% to about 70% by weight of a surfactant system.

Even more preferably, the cleaning compositions of the present invention comprising at least one inventive polymer, and optionally further comprising at least one surfactant or a surfactant system, are those for primary cleaning (i.e., removal of stains) within laundry and manual dish wash applications, even more specifically, for removal of clay or oily and fatty stains such as those on fabrics and dishware, and may additionally comprise at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types of enzymes, more preferably at least one enzyme being selected from proteases.

In one preferred embodiment, the cleaning composition of the present invention is a liquid or solid laundry detergent composition.

In another preferred embodiment, the cleaning composition of the present invention is a liquid or solid (e.g., powder or tab/unit dose) detergent composition for manual or automatic dish wash, preferably either a liquid manual dish wash detergent composition or a solid automatic dish wash composition.

In one embodiment, the inventive polymers of the present invention may be utilized in cleaning compositions comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive polymers may be utilized in cleaning compositions, such as laundry detergents of any kind, and the like, comprising C8-C18 linear or branched alkyl ether sulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive polymers may be utilized in cleaning compositions, such as laundry detergents of any kind, and the like, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In a further embodiment the inventive polymers may be utilized in cleaning compositions, such as laundry detergents of any kind, and the like, comprising bio-based surfactants like rhamnolipids and/or sophorolipids as the primary surfactant.

In one embodiment of the present invention, the inventive polymer is a component of a cleaning composition, such as preferably a laundry or a dish wash formulation, more preferably a liquid laundry or manual dish wash formulation, that each additionally comprise at least one surfactant, preferably at least one anionic surfactant.

The selection of the additional surfactants in these embodiments may be dependent upon the application and the desired benefit.

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e., contain other ingredients), “consist essentially of” (comprise mainly or almost only the mentioned ingredients and other ingredients in only very minor amounts, mainly only as impurities), or “consist of” (i.e., contain only the mentioned ingredients and in addition may contain only impurities not avoidable in a technical environment, preferably only the ingredients) the components of the present disclosure.

The term “at least one”, as used herein, includes but is not limited to 1, 2, 3, 4, 5, 6, 7, 8, 9 and more.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition. The term “about”, as used herein, encompasses the exact number “X” mentioned as e.g., “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course, if the value X given itself is already “100%” (such as for purity etc.) then the term “about” clearly can and thus does only mean deviations thereof which are smaller than “100”.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under atmospheric pressure. In all embodiments of the present disclosure, all percentages are by weight of the total composition, unless specifically stated otherwise. All ratios are weight ratios, unless specifically stated otherwise.

Description of Cleaning Compositions, Formulations and their Ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces. “Compositions for Fabric and Home Care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below when describing the use and application of the inventive polymers and compositions comprising such polymers.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20° C.; liquid laundry cleaning compositions have a viscosity of preferably from 50 to 3000 mPa*s, more preferably from 100 to 1500 mPa*s and most preferably from 200 to 1000 mPa*s at 20 1/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, dye fixation agent and perfumes.

Liquid cleaning compositions additionally may comprise—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

### (a) Laundry Compositions

In laundry formulations, anionic surfactants contribute usually by far the largest share of surfactants within such formulation. Hence, preferably, the inventive cleaning compositions for use in laundry comprise at least one anionic surfactant and optionally further surfactants selected from any of the surfactant classes described herein, preferably from non-ionic surfactants and/or amphoteric surfactants and/or zwitterionic surfactants and/or cationic surfactants.

Nonlimiting examples of anionic surfactants—which may be employed also in combinations of more than one surfactant—useful herein include C9-C20 linear alkylbenzenesulfonates (LAS), C10-C20 primary, branched chain and random alkyl sulfates (AS); C10-C18 secondary (2,3) alkyl sulfates; C10-C18 alkyl alkoxy sulfates (AExS) wherein x is from 1 to 30; C10-C18 alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C8-C12-alkyl sulfates, of C12-C18-fatty alcohol ether sulfates, of C12-C18-fatty alcohol polyether sulfates, of sulfuric acid half-esters of ethoxylated C4-C12-alkylphenols (ethoxylation: 3 to 50 mol of ethylene oxide/mol), of C12-C18-alkylsulfonic acids, of C12-C18 sulfo fatty acid alkyl esters, for example of C12-C18 sulfo fatty acid methyl esters, of C10-C18-alkylarylsulfonic acids, preferably of n-C10-C18-alkylbenzene sulfonic acids, of C10-C18 alkyl alkoxy carboxylates and of soaps such as for example C8-C24-carboxylic acids. Preference is given to the alkali metal salts of the aforementioned compounds, particularly preferably the sodium salts. In one embodiment of the present invention, anionic surfactants are selected from n-C10-C18-alkylbenzene sulfonic acids and from fatty alcohol polyether sulfates, which, within the context of the present invention, are in particular sulfuric acid half-esters of ethoxylated C12-C18-alkanols (ethoxylation: 1 to 50 mol of ethylene oxide/mol), preferably of n-C12-C18-alkanols. In one embodiment of the present invention, also alcohol polyether sulfates derived from branched (i.e., synthetic) C11-C18-alkanols (ethoxylation: 1 to 50 mol of ethylene oxide/mol) may be employed.

Preferably, the alkoxylation group of both types of alkoxylated alkyl sulfates, based on C12-C18-fatty alcohols or based on branched (i.e., synthetic) C11-C18-alcohols, is an ethoxylation group and an average ethoxylation degree of any of the alkoxylated alkyl sulfates is 1 to 5, preferably 1 to 3.

In a further embodiment of the present invention, anionic surfactants are selected from rhamnolipids and/or sophorolipids.

Preferably, the laundry detergent formulation of the present invention comprises from at least 1 wt.-% to 50 wt.-%, preferably in the range from greater than or equal to about 2 wt.-% to equal to or less than about 30 wt.-%, more preferably in the range from greater than or equal to 3 wt.-% to less than or equal to 25 wt.-%, and most preferably in the range from greater than or equal to 5 wt.-% to less than or equal to 25 wt.-% of one or more anionic surfactants as described above, based on the particular overall composition, including other components and water and/or solvents.

In a preferred embodiment of the present invention, anionic surfactants are selected from C10-C15 linear alkylbenzenesulfonates, C10-C18 alkylethersulfates with 1-5 ethoxy units and C10-C18 alkylsulfates.

Non-limiting examples of non-ionic surfactants—which may be employed also in combinations of more than one other surfactant—include: C8-C18 alkyl ethoxylates, such as, NEODOL® non-ionic surfactants from Shell; ethylenoxide/propylenoxide block alkoxylates as PLURONIC® from BASF; C14-C22 mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides).

Preferred examples of alkoxylated alcohols and alkoxylated fatty alcohols are, for example, compounds of the general formula (A)

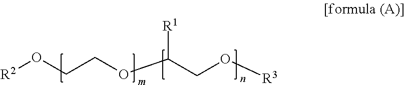

in which the variables are defined as follows:
R1 is selected from linear C1-C10-alkyl, preferably ethyl and particularly preferably methyl,
R2 is selected from C8-C22-alkyl, for example n-C8H17, n-C10H21, n-C12H25, n-C14H29, n-C16H33 or n-C18H37,
R3 is selected from C1-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

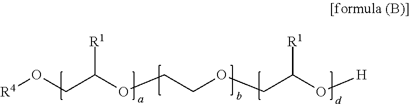

in which the variables are defined as follows:
R1 is identical or different and selected from linear C1-C4-alkyl, preferably identical in each case and ethyl and particularly preferably methyl,
R4 is selected from C6-C20-alkyl, in particular n-C8H17, n-C10H21, n-C12H25, n-C14H29, n-C16H33, n-C18H37,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187. Mixtures of two or more different non-ionic surfactants may of course also be present.

In a preferred embodiment of the present invention, non-ionic surfactants are selected from C12/14 and C16/18 fatty alkoholalkoxylates, C13/15 oxoalkoholalkoxylates, C13-alkoholalkoxylates, and 2-propylheptylalkoholalkoxylates, each of them with 3-15 ethoxy units, preferably 4-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R1=C8-18 alkyl moiety and two R2 and R3 moieties selected from the group consisting of C1-C3 alkyl groups and C1-C3 hydroxyalkyl groups. Preferably, the amine oxide is characterized by the formula

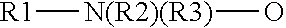

wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1−n2) is less than or equal to 5, preferably 4, most preferably from 0 to 4 carbon atoms in at least 50 wt.-%, more preferably at least 75 wt.-% to 100 wt.-% of the mid-branched amine oxides for use herein. The amine oxide further comprises two moieties, independently selected from a C1-C3 alkyl, a C1-C3 hydroxyalkyl group, or a polyethylene oxide group containing an average of from about 1 to about 3 ethylene oxide groups. Preferably the two moieties are selected from a C1-C3 alkyl, more preferably both are selected as a C1 alkyl.

In a preferred embodiment of the present invention, amphoteric surfactants are selected from C8-C18 alkyl-dimethyl aminoxides and C8-C18 alkyl-di(hydroxyethyl)aminoxide.

Cleaning compositions may also contain zwitterionic surfactants—which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleamidopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleamidopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C12-C18-alkylbetaines and sulfobetaines. The zwitterionic surfactant preferably is a betaine surfactant, more preferably a Cocoamidopropylbetaine surfactant.

Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na2CO3.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylenephosphonate (EDTMP), diethylenetriaminepentamethylenephosphonate (DTPMP), and also their higher homologues. They are preferably used in the form of the neutrally reacting sodium salts, e.g., as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na2Si2O5, β-Na2Si2O5, and δ-Na2Si2O5.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C2-C16-alkyl disuccinates, C2-C16-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight Mw in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid. It is also possible to use copolymers of at least one monomer from the group consisting of monoethylenically unsaturated C3-C10-mono- or C4-C10-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C22-α-olefin, a mixture of C20-C24-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment of the present invention, the composition or laundry formulation according to the invention comprises additionally at least one enzyme.

In one embodiment, the composition according to the present invention additionally comprises at least one enzyme.

Preferably, the at least one enzyme is a detergent enzyme.

In one embodiment, the enzyme is classified as an oxidoreductase (EC 1), a transferase (EC 2), a hydrolase (EC 3), a lyase (EC 4), an isomerase (EC 5), or a ligase (EC 6). The EC-numbering is according to Enzyme Nomenclature, Recommendations (1992) of the Nomenclature Committee of the International Union of Biochemistry and Molecular Biology including its supplements published 1993-1999. Preferably, the enzyme is a hydrolase (EC 3).

In a preferred embodiment, the enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and combinations of at least two of the foregoing types. More preferably, the enzyme is selected from the group consisting of proteases, amylases, lipases, cellulases, mannanases, xylanases, DNases, dispersins, pectinases, oxidoreductases, and cutinases, and combinations of at least two of the foregoing types. Most preferably, the enzyme is a protease, preferably, a serine protease, more preferably, a subtilisin protease.

Preferably, the protease is a protease with at least 90% sequence identity to SEQ ID NO: 22 of EP1921147B1 and having the amino acid substitution R101E (according to BPN′ numbering). Preferably, the amylase is an amylase with at least 90% sequence identity to SEQ ID NO: 54 of WO2021032881A1.

The composition of the present invention can comprise one type of enzyme or more than one enzyme of different types, e.g., an amylase and a protease, or more than one enzyme of the same type, e.g., two or more different proteases, or mixtures thereof, e.g., an amylase and two different proteases.

The enzyme(s) can be incorporated into the composition at levels sufficient to provide an effective amount for achieving a beneficial effect, preferably for primary washing effects and/or secondary washing effects, like anti-greying or antipilling effects (e.g., in case of cellulases). Preferably, the enzyme is present in the composition at levels from about 0.00001% to about 5%, preferably from about 0.00001% to about 2%, more preferably from about 0.0001% to about 1%, or even more preferably from about 0.001% to about 0.5% enzyme protein by weight of the composition.

Preferably, the enzyme-containing composition further comprises an enzyme stabilizing system. Preferably, the enzyme-containing composition described herein comprises from about 0.001% to about 10%, from about 0.005% to about 8%, or from about 0.01% to about 6%, by weight of the composition, of an enzyme stabilizing system. The enzyme stabilizing system can be any stabilizing system which is compatible with the enzyme.

Preferably, the enzyme stabilizing system comprises at least one compound selected from the group consisting of polyols (preferably, 1,3-propanediol, ethylene glycol, glycerol, 1,2-propanediol, or sorbitol), inorganic salts (preferably, CaCl2, MgCl2, or NaCl), short chain (preferably, C1-C3) carboxylic acids or salts thereof (preferably, formic acid, formate (preferably, sodium formate), acetic acid, acetate, or lactate), borate, boric acid, boronic acids (preferably, 4-formyl phenylboronic acid (4-FPBA)), peptide aldehydes (preferably, Z-VAL-H or Z-GAY-H), peptide acetals, and peptide aldehyde hydrosulfite adducts. Preferably, the enzyme stabilizing system comprises a combination of at least two of the compounds selected from the group consisting of salts, polyols, and short chain carboxylic acids and preferably one or more of the compounds selected from the group consisting of borate, boric acid, boronic acids (preferably, 4-formyl phenylboronic acid (4-FPBA)), peptide aldehydes, peptide acetals, and peptide aldehyde hydrosulfite adducts. In particular, if proteases are present in the composition, protease inhibitors may be added, preferably selected from borate, boric acid, boronic acids (preferably, 4-FPBA), peptide aldehydes (preferably, peptide aldehydes like Z-VAL-H or Z-GAY-H), peptide acetals, and peptide aldehyde hydrosulfite adducts.

Compositions according to the invention may comprise one or more bleaching agent (bleaches).

Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H2SO5 and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, (S)NOBS, LOBS, DOBA, PAP, N-methylmorpholiniumacetonitrile salts (“MMA salts”), trimethylammonium acetonitrile salts, N-acylamides such as, for example, N-nonanoylsuccinimide, 1,5-diacetyl-2,2-dioxohexahydro-1,3,5-triazine (“DADHT”) or nitrile quats (trimethylammonium acetonitrile salts).

As precursors of H₂O₂ peroxides come into consideration. i. e. every compound which is capable of yielding hydrogen peroxide in aqueous solutions, for example, the organic and inorganic peroxides known in the literature and available commercially that bleach textile materials at conventional washing temperatures, for example at from 10 to 95° C.

Preferably, however, inorganic peroxides are used, for example persulfates, perborates, percarbonates and/or persilicates. They are typically used in an amount of 2-80 wt-%, preferably of 4-30 wt-%, based on the weight of the composition.

Typically the compound of formula (1)

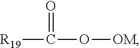

as described in more detail below, is present in the composition in an amount of 0.05-15 wt-%, preferably from 0.1 to 10 wt-%, based on the weight of the total composition.

Examples of suitable inorganic peroxides are sodium perborate tetrahydrate or sodium perborate monohydrate, sodium percarbonate, inorganic peroxyacid compounds, such as for example potassium monopersulphate (MPS). If organic or inorganic peroxyacids are used as the peroxygen compound, the amount thereof will normally be within the range of about 2-80 wt-%, preferably from 4-30 wt-%, based on the weight of the composition.

The organic peroxides are, for example, mono- or poly-peroxides, urea peroxides, a combination of a C₁-C₄alkanol oxidase and C₁-C₄alkanol (Such as methanol oxidase and ethanol as described in WO95/07972), alkylhydroxy peroxides, such as cumene hydroperoxide and t-butyl hydroperoxide.

The peroxides may be in a variety of crystalline forms and have different water contents, and they may also be used together with other inorganic or organic compounds in order to improve their storage stability.

As oxidants, peroxo acids can also be used. One example are organic mono peracids of formula (1)

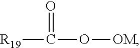

wherein
M signifies hydrogen or a cation,
R₁₉ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted.

Preferred mono organic peroxy acids and their salts are those of formula

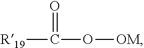

wherein
M signifies hydrogen or an alkali metal, and
R′₁₉ signifies unsubstituted C₁-C₄alkyl; phenyl; —C₁-C₂alkylene-phenyl or phthalimidoC₁-C₈alkylene.

Especially preferred is CH₃COOOH and its alkali salts.

Especially preferred is also □-phthalimido peroxy hexanoic acid and its alkali salts (PAP). Also suitable are diperoxyacids, for example, 1,12-diperoxydodecanedioic acid (DPDA), 1,9-diperoxyazelaic acid, diperoxybrassilic acid, diperoxysebasic acid, diperoxyisophthalic acid, 2-decyldiperoxybutane-1,4-diotic acid and 4,4′-sulphonylbisperoxybenzoic acid.

In some cases the use of an additional bleach activator may be of advantage.

The term bleach activator is frequently used as a synonym for peroxyacid bleach precursor. All the above mentioned peroxy compounds may be utilized alone or in conjunction with a peroxyacid bleach precursor.

Such precursors are the corresponding carboxyacid or the corresponding carboxyanhydride or the corresponding carbonylchlorid, or amides, or esters, which can form the peroxy acids on perhydrolysis. Such reactions are commonly known.

Peroxyacid bleach precursors are known and amply described in literature, such as in the British U.S. Pat. No. 836,988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Suitable bleach activators include the bleach activators, that carry O- and/or N-acyl groups and/or unsubstituted or substituted benzoyl groups. Preference is given to polyacylated alkylenediamines, especially tetraacetylethylenediamine (TAED); acylated glycolurils, especially tetraacetyl glycol urea (TAGU), N, N-diacetyl-N, N-dimethylurea (DDU); sodium-4-benzoyloxy benzene sulphonate (SBOBS); sodium-1-methyl-2-benzoyloxy benzene-4-sulphonate; sodium-4-methyl-3-benzoloxy benzoate; trimethyl ammonium toluyloxy-benzene sulphonate; acylated triazine derivatives, especially 1,5-diacetyl-2,4-dioxohexahydro-1,3,5-triazine (DADHT); compounds of formula (10):

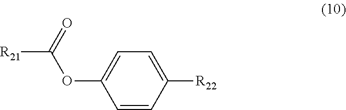

wherein R₂₂ is a sulfonate group, a carboxylic acid group or a carboxylate group, and wherein R₂₁ is linear or branched (C₇-C₁₅)alkyl, especially activators known under the names SNOBS, SLOBS and DOBA; acylated polyhydric alcohols, especially triacetin, ethylene glycol diacetate and 2,5-diacetoxy-2,5-dihydrofuran; and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are: 2-(N, N, N-trimethyl ammonium) ethyl sodium-4-sulphonphenyl carbonate chloride—(SPCC), N-octyl,N,N-dimehyl-N10-carbophenoxy decyl ammonium chloride—(ODC), 3-(N,N,N-trimethyl ammonium) propyl sodium-4-sulphophenyl carboxylate and N,N,N-trimethyl ammonium toluyloxy benzene sulphonate.

It is also possible to use additional bleach catalysts, which are commonly known, for example transition metal complexes as disclosed in EP 1194514, EP 1383857 or WO04/007657.

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional alkoxylated polyethylene imines” (for example BASF's Sokalan® HP20), “multifunctional alkoxylated diamines” (for example BASF's Sokalan® HP96), BASF's Sokalan® SR400 A and also terephthalic acid-based polyesters like Clariant's TexCare®, such as TexCare® SRN 170, TexCare® SRN 172, TexCare® SRN 260, TexCare® SRN 260 SG Terra and TexCare® SRA 300 as well as distinct combinations of all of the before mentioned polymers.

Suitable multifunctional alkoxylated polyethylene imines are typically ethoxylated polyethylene imines with a weight-average molecular weight Mw in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional alkoxylated polyethylene imines have 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight Mw in the range of 500 to 5000 g/mol. Preferably employed is a molecular weight from 500 to 1000 g/mol, even more preferred is a Mw of 600 to 800 g/mol. The ethoxylated polymer then has on average 5 to 50, preferably 10 to 35 and even more preferably 20 to 35 ethylene oxide (EO) units per NH-functional group.

Suitable multifunctional alkoxylated diamines are typically ethoxylated C2 to C12 alkylene diamines, preferably hexamethylene diamine, which are further quaternized and optionally sulfated. Typical multifunctional alkoxylated diamines have a weight-average molecular weight Mw in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional alkoxylated polyethylene imine and/or at least one multifunctional alkoxylated diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt.-%, preferably from 0.1 to 10 wt.-% and more preferably from 0.25 to 5 wt.-% and even as low as up to 2 wt. %, based on the particular overall composition, including other components and water and/or solvents.

In another preferred embodiment of the present invention, the cleaning compositions may contain at least one terephthalic acid-based polyester, employed as soil release polymer, to improve the whiteness of the fabrics after the wash, especially the whiteness of polyester fabrics. Thus, one aspect of the present invention is a laundry detergent composition, in particular a liquid laundry detergent, comprising (i) at least one inventive polymer and (ii) at least one compound selected from multifunctional alkoxylated polyethylene imines, multifunctional alkoxylated diamines and terephthalic acid-based polyesters, and mixtures thereof.

In one embodiment of the present invention, the ratio of the at least one inventive polymer and (ii) the at least one compound selected from multifunctional polyethylene imines and multifunctional diamines and mixtures thereof, is from 10:1 to 1:10, preferably from 5:1 to 1:5 and more preferably from 3:1 to 1:3.

Laundry formulations comprising the inventive polymer may also comprise at least one antimicrobial agent (also often named preservatives).

The composition may contain one or more antimicrobial agents and/or preservatives as listed in patent WO2021/115912 A1 on pages 35 to 39.

Especially of interest are the following antimicrobial agents and/or preservatives: 4,4′-dichloro 2-hydroxydiphenyl ether (CAS-No. 3380-30-1), further names: 5-chloro-2-(4-chlorophenoxy) phenol, Diclosan, DCPP, which is commercially avail-able as a solution of 30 wt % of 4,4′-dichloro 2-hydroxydiphenyl ether in 1,2 propyl-eneglycol under the trade name Tinosan® HP 100 (BASF); 2-Phenoxyethanol (CAS-no. 122-99-6, further names: Phenoxyethanol, Methylphenylglycol, Phenoxetol, ethylene glycol phenyl ether, Ethylene glycol monophenyl ether, Protectol® PE); 2-bromo-2-nitropropane-1,3-diol (CAS-No. 52-51-7, further names: 2-bromo-2-nitro-1,3-propanediol, Bronopol®, Protectol® BN, Myacide AS); Glutaraldehyde (CAS-No. 111-30-8, further names: 1-5-pentandial, pentane-1,5-dial, glutaral, glutardialdehyde, Protectol® GA, Protectol® GA 50, Myacide® GA); Glyoxal (CAS No. 107-22-2; further names: ethandial, oxylaldehyde, 1,2-ethandial, Protectol® GL); 2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3 (2H)-one (BIT, CAS No. 2634-33-5); Hexa-2,4-dienoic acid (Sorbic acid, CAS No. 110-44-1) and its salts, e.g. calcium sorbate, sodium sorbate, potassium (E,E)-hexa-2,4-dienoate (Potassium Sorbate, CAS No. 24634-61-5); Lactic acid and its salts; L-(+)-lactic acid (CAS No. 79-33-4); Benzoic acid and its sodium salt (CAS No 65-85-0, CAS No. 532-32-1) and salts of benzoic acid e.g. ammonium benzoate, calcium benzoate, magnesium benzoate, MEA-benzoate, potassium benzoate; Salicylic acid and its salts, e.g. calcium salicylate, magnesium salicylate, MEA salicylate, sodium salicylate, potassium salicylate, TEA salicylate; Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-y71-7, 85409-22-9); Didecyldimethylammonium chloride (DDAC, CAS No. 68424-95-3 and CAS No. 7173-51-5); N-(3-aminopropyl)-N-dodecylpropane-1,3-diamine (Diamine, CAS No. 2372-82-9); Peracetic acid (CAS No. 79-21-0); Hydrogen peroxide (CAS No. 7722-84-1).

The antimicrobial agent is added to the composition in a concentration of 0.001 to 10% relative to the total weight of the composition.

Preferably, the composition contains 2-Phenoxyethanol in a concentration of 0.1 to 2% or 4,4′-dichloro 2-hydroxydiphenyl ether (DCPP) in a concentration of 0.005 to 0.6%.

The invention thus further encompasses a method of preserving an aqueous composition according to the invention against microbial contamination or growth, which method comprises addition of 2-Phenoxyethanol. The invention thus further encompasses a method of providing an antimicrobial effect on textiles after treatment with a solid laundry detergent e.g., powders, granulates, capsules, tablets, bars etc.), a liquid laundry detergent, a softener or an after rinse containing 4,4′-dichloro 2-hydroxydiphenyl ether (DCPP).

In a further embodiment, this invention also encompasses a composition comprising an inventive polymer as descried herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising an inventive polymer as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichloro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichloro 2-hydroxydiphenylether.

The term “dye fixation agent”, as used herein, relates to compounds that attenuate or even terminate dye bleeding of colored fabrics during the washing process. Dye fixation agents include, but are not limited to cationic dye fixation agents, crosslinking fixation agents and formaldehyde-based fixation agents. The skilled person is well-aware of these compounds and may purchase commercially available products from BASF SE, Huntsman, Archroma, Fineotex, Biotex Malaysia or Dystar. Exemplified, but not limiting dye fixation agents are Basilen Fixing Agent F-RP, Albafix ECO, Finofix NF, poly DADMAC, Polyamine (DCDA-DETA, Epichloro-DMA, Epichloro-DETA, etc.).

Formulations according to the invention may also comprise water and/or additional organic solvents, e.g., ethanol or propylene glycol.

Further optional ingredients may be but are not limited to viscosity modifiers, cationic surfactants, foam boosting or foam reducing agents, perfumes, dyes, optical brighteners, and dye transfer inhibiting agents.

### (b) General Cleaning Compositions and Formulations

The liquid formulations disclosed in this chapter may comprise 0 to 2% 2-phenoxyethanol, preferably about 1%, in addition to all other mentioned ingredients.

The above and below disclosed liquid formulations may comprise 0-0,2% 4,4′-dichloro 2-hydroxydiphenylether, preferably about 0, 15%, in addition to all other mentioned ingredients.

The bleach-free solid laundry compositions may comprise 0-0.2% 4,4′-dichloro 2-hydroxydiphenylether, preferably about 0.15%, in addition to all other mentioned ingredients.

The formulations disclosed in this chapter may—in addition to all other mentioned ingredients—comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101E (according to BPN′ numbering) and wherein the amylase is an amylase with at least 90% sequence identity to SEQ ID NO: 54 of WO2021032881A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The following compositions shown below including those in the tables disclose general cleaning compositions of certain types, which correspond to typical compositions correlating with typical washing conditions as typically employed in various regions and countries of the world. The at least one inventive polymer may be added to such formulation(s) in suitable amounts as outlined herein.

When the shown composition does not comprise an inventive polymer, such composition is a comparative composition. When it comprises an inventive polymer, especially in the amounts that are described herein as preferred, more preferred etc. ranges, such compositions are considered to fall within the scope of the present invention.

In a preferred embodiment the at least one modified alkoxylated polyalkylene imine or modified alkoxylated polyamine (as defined in any of the embodiments herein, especially the Embodiments 1 to 15; modified alkoxylated polyalkylene imines or modified alkoxylated polyamines in this section also named “inventive polymer”) is used in a laundry detergent.

Liquid laundry detergents according to the present invention are composed of:

| | |
|---|---|
| 0.05-20% | of at least one inventive polymer |
| 1-50% | of surfactants |
| 0.1-40% | of builders, cobuilders and/or chelating agents |
| 0.1-50% | other adjuncts |
| water | to add up 100%. |

Preferred liquid laundry detergents according to the present invention are composed of:

| | |
|---|---|
| 0.2-6% | of at least one inventive polymer |
| 5-40% | of anionic surfactants selected from C10-C15- LAS and C10-C18 alkyl ether |
| | sulfates containing 1-5 ethoxy-units |
| 1.5-10% | of nonionic surfactants selected from C10-C18-alkyl ethoxylates containing |
| | 3-10 ethoxy-units |
| 2-20% | of soluble organic builders/cobuilders selected from C10-C18 fatty acids, di- |
| | and tricarboxylic acids, hydroxy-di- and hydroxytricaboxylic acids and |
| | polycarboxylic acids |
| 0.05-5% | of an enzyme system containing at least one enzyme suitable for detergent use |
| | and preferably also an enzyme stabilizing system |
| 0.5-20% | of mono- or diols selected from ethanol, isopropanol, ethylene glycol, or |
| | propylene glyclol |
| 0.1-20% | other adjuncts |
| water | to add up to 100%. |

Solid laundry detergents (like e.g., powders, granules or tablets) according to the present invention are composed of:

| | |
|---|---|
| 0.05-20% | of at least one inventive polymer |
| 1-50% | of surfactants |
| 0.1-80% | of builders, cobuilders and/or chelating agents |
| 0-50% | fillers |
| 0-40% | bleach actives |
| 0.1-30% | other adjuncts and/or water |

wherein the sum of the ingredients adds up 100%.

Preferred solid laundry detergents according to the present invention are composed of:

| | |
|---|---|
| 0.2-6% | of at least one inventive polymer |
| 5-30% | of anionic surfactants selected from C10-C15- LAS, C10-C18 alkyl sulfates and |
| | C10-C18 alkyl ether sulfates containing 1-5 ethoxy-units |
| 1.5-7.5% | of non-ionic surfactants selected from C10-C18-alkyl ethoxylates containing |
| | 3-10 ethoxy-units |
| 5-50% | of inorganic builders selected from sodium carbonate, sodium bicarbonate, |
| | zeolites, soluble silicates, sodium sulfate |
| 0.5-15% | of cobuilders selected from C10-C18 fatty acids, di- and tricarboxylic acids, |
| | hydroxydi- and hydroxytricarboxylic acids and polycarboxylic acids |
| 0.1-5% | of an enzyme system containing at least one enzyme suitable for detergent use |
| | and preferably also an enzyme stabilizing system |
| 0.1-20% | other adjuncts |
| water | to add up to 100%. |

In a preferred embodiment the polymer according to the present invention is used in a manual dish wash detergent.

Liquid manual dish wash detergents according to the present invention are composed of:

| | |
|---|---|
| 0.05-10% | of at least one inventive polymer |
| 1-50% | of surfactants |
| 0.1-50% | of other adjuncts |
| water | to add up 100%. |

Preferred liquid manual dish wash detergents according to the present invention are composed of:

| | |
|---|---|
| 0.2-5% | of at least one inventive polymer |
| 5-40% | of anionic surfactants selected from C10-C15- LAS, C10-C18 alkyl ether |
| | sulfates containing 1-5 ethoxy-units, and C10-C18 alkyl sulfate |
| 0-10% | of Cocamidopropylbetaine |
| 0-10% | of Lauramine oxide |
| 0-2% | of a non-ionic surfactant, preferably a C10-Guerbet alcohol alkoxylate |
| 0-5% | of an enzyme, preferably Amylase, and preferably also an enzyme stabilizing |
| | system |
| 0.5-20% | of mono- or diols selected from ethanol, isopropanol, ethylene glycol, or |
| | propylene glyclol |
| 0.1-20% | other adjuncts |
| water | to add up to 100% |

As the polyalkylene imine or polyamine polymers of the invention are biodegradable, and especially the cleaning formulations typically have a pH of about 7 or higher, and additionally often contain also enzymes—which are included into such cleaning formulations to degrade biodegradable stuff such as grease, proteins, polysaccharides etc. which are present in the stains and dirt which shall be removed by the cleaning compositions—some consideration is needed to be taken to formulate those bio-degradable polymers of the invention. Such formulations suitable are in principle known, and include the formulation in solids—where the enzymes and the polymers can be separated by coatings or adding them in separate particles which are mixed—and liquids and semi-liquids, where the polymers and the enzymes can be separated by formulating them in different compartments, such as different compartments of multichamber-pouches or bottles having different chambers, from which the liquids are poured out at the same time in a predefined amount to assure the application of the right amount per individual point of use of each component from each chamber. Such multi-compartment-pouches and bottles etc. are known to a person of skill as well.

The following table shows general cleaning compositions of certain types, which correspond to typical compositions correlating with typical washing conditions as typically employed in various regions and countries of the world. The at least one inventive polymer may be added to such formulation(s) in suitable amounts as outlined herein.

TABLE 1
General formula for laundry detergent compositions
according to the invention:

| | Ranges of Ingredient in |
|---|---|
| Ingredient | Liquid frame formulations |
| Linear alkyl benzene sulphonic acid | 0 to 30% |
| Coco fatty acid | 1 to 12% |
| Fatty alcohol ether sulphate | 0 to 25% |
| NaOH or mono- or triethanolamine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

TABLE 2
Liquid laundry frame formulations according to the invention:

| | active | | | | | |
|---|---|---|---|---|---|---|
| (numbers: % active) | F1 | F2 | F3 | F4 | F5 | F6 |
| alcohol ethoxylate 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether sulphate | 5.40 | 8.80 | 7.10 | 7.10 | 5.40 | 14.00 |
| Linear alkyl benzene sulphonic | 5.50 | 0.00 | 14.50 | 15.50 | 10.70 | 0.00 |
| acid | | | | | | |
| 1,2 Propane diol | 6.00 | 3.50 | 8.70 | 8.70 | 1.10 | 7.80 |
| Triethanolamine | | | | | | |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| Inventive Polymer (s) (total)* | 0-5 | 0-5 | 0-5 | 0-5 | 0-5 | 0-5 |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

| | active | | | | | | | |
|---|---|---|---|---|---|---|---|---|
| (numbers: % active) | F7 | F8 | F9 | F10 | F11 | F12 | F13 | F14 |
| alcohol ethoxylate 7EO | 3.80 | 0.30 | 13.30 | 8.00 | 5.70 | 20.00 | 9.20 | 29.00 |
| Coco fatty acid K12-18 | 2.80 | 3.00 | 1.70 | 1.80 | 2.50 | 5.00 | 8.60 | 10.40 |
| Fatty alcohol ether sulphate | 2.80 | 4.50 | 3.90 | 4.10 | | 10.00 | 22.20 | |
| Linear alkyl benzene sulphonic | 6.30 | 5.43 | 11.45 | 5.90 | 10.10 | 10.00 | 28.00 | 27.00 |
| acid | | | | | | | | |
| 1,2 Propane diol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| Inventive Polymer (s) (total)* | 0-5 | 0-5 | 0-5 | 0-5 | 0-5 | 0-5 | 0-5 | 0-5 |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

*Without inventive polymer the formulations are comparative examples.

TABLE 3
Laundry powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether sulphate | 1.5 | 0 | 0 | 0 | 0 | 6 |
| Linear alkyl benzene sulphonic | 12.1 | 11.2 | 13.6 | 21.9 | 18.7 | 12.7 |
| acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phosphate | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| Inventive Polymer(s) (total) | 1 | 1 | 0.2 | 2 | 0.5 | 3 |
| | Bleach containing Powder | | | | | |
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether sulphate | 0 | 3.9 | 4.4 | 1.6 | 0 | 0 |
| Linear alkyl benzene sulphonic | 7.6 | 12.1 | 11.5 | 12.2 | 6.5 | 10.4 |
| acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phosphate | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive Polymer(s) (total) | 2.2 | 9.2 | 2.2 | 0.7 | 1 | 0.4 |

TABLE 4
Liquid manual dish wash frame formulations according to the invention:

| Ingredients | MDW.1 | MDW.2 | MDW.3 | MDW.4 | MDW.5 | MDW.6 | MDW.7 | MDW.8 |
|---|---|---|---|---|---|---|---|---|
| Linear C₁₂-C₁₄-alkyl- | 8 | 0 | 6 | 0 | 6 | 0 | 6 | 0 |
| benzenesulfonic acid | | | | | | | | |
| C₁₂-C₁₄-fatty alcohol × 2 EO | 8 | 16 | 6 | 12 | 6 | 12 | 6 | 12 |
| sulfate | | | | | | | | |
| Cocamidopropyl betaine | 0 | 0 | 4 | 4 | 0 | 0 | 2 | 2 |
| Lauramine oxide | 0 | 0 | 0 | 0 | 4 | 4 | 2 | 2 |
| 2-Propylheptanol × 4 EO | 0.5 | 0.5 | 0.5 | 0.5 | 0.5 | 0.5 | 0.5 | 0.5 |
| Inventive | 1 | 1 | 1 | 1 | 1 | 1 | 1 | 1 |
| Polymer (s) (total) | | | | | | | | |
| Ethanol | 2 | 2 | 2 | 2 | 2 | 2 | 2 | 2 |
| 2-Phenoxyethanol (pre- | 1 | 1 | 1 | 1 | 1 | 1 | 1 | 1 |
| servative) | | | | | | | | |
| Sodium chloride | 1 | 1 | 1 | 1 | 1 | 1 | 1 | 1 |
| Demin. water | add 100 | add 100 | add 100 | add 100 | add 100 | add 100 | add 100 | add 100 |
| Sodium hydroxide | add | add | add | add | add | add | add | add |
| | pH 8 | pH 8 | pH 8 | pH 8 | pH 8 | pH 8 | pH 8 | pH 8 |

The following examples shall further illustrate the present invention without restricting the scope of the invention.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

### EXAMPLES

In the following, “CL/NH” means caprolactone (CL) repeating units per NH-functionality of the polyalkylene imine or polyamine, as employed in step a), “EO/NH” means ethylene oxide (EO) repeating units per NH-functionality of the polyalkylene imine or polyamine, as employed in step a), “PO/NH” means propylene oxide (PO) repeating units per NH-functionality of the polyalkylene imine or polyamine, as employed in step a).

The amount of ε-caprolactone, ethylene oxide and propylene oxide added in the below described reactions is calculated based on the determined OH number of the precursor polymer.

In the Tables below, the amount of ε-caprolactone, ethylene oxide and propylene oxide is recalculated to obtain the equivalents of ε-caprolactone, ethylene oxide and propylene oxide added per NH-functionality of the polyalkylene imine or polyamine, as employed in step a), to ensure consistency with the definitions chosen in the claims and throughout this patent application. Abbreviations used, in particular in the Tables: PDI=polydispersity index; MW=molecular weight as determined by multi-angle light scattering (MALLS or LS); hbPEI=hyperbranched poly(ethylene imine); CL=ε-caprolactone; EO=ethylene oxide; PO=propylene oxide; LOM=launder-o-meter; HP20=Sokalan® HP20=ethoxylated PEI.

### 1) Synthesis Examples

### a) Synthesis of Examples for Clay Stains Removal

An overview of the prepared examples can be found in Table 5.

TABLE 5
Overview of prepared examples for clay stains removal

| | | MW | | Biodegradability |
|---|---|---|---|---|
| | | (g/mol, | | (%, 28 d, |
| Polymer | Chemistry | LS) | PDI | OECD 301F) |
| Ref. 1 | Sokalan ® HP20 | 10.200 | 1.3 | <5 |
| Ref. 2 | hbPEI800 - 2 CL/NH - | 8.900 | 2.4 | 50 |
| | 19 EO/NH | | | |
| 1.1 | hbPE1800 - 1 CL/NH - | 15.500 | 3.5 | 60 |
| | (2 CL - mix- 25 EO)/NH | | | |
| 1.2 | hbPEI800 - 1 CL/NH - | 19.000 | 3.5 | 54 |
| | (3 CL - mix- 25 EO)/NH | | | |

### i) Synthesis of Polymers 1.1 and 1.2.

Polymers 1.1 and 1.2. have both been prepared in a 2-step process:

1) Synthesis of hbPEI800—1 CL/NH

150 g of poly(ethylene imine) with MW 800 (Lupasol® FG, commercially available from BASF SE, Germany) and 7.5 g of potassium methanolate (32.5 wt % in methanol) are charged into a one-necked round bottom flask. At the rotary evaporator, the mixture was heated for 2 hours at 80° C. and reduced pressure to remove methanol. The mixture was then cooled down and transferred to a four-necked round bottom flask equipped with a cooler and a dripping funnel under nitrogen atmosphere. The reaction mixture is heated to 80° C. and 401.5 g of ε-caprolactone are added slowly at 80° C. After caprolactone addition, the temperature is increased slowly to 160° C. and the mixture is allowed to post-react for ten hours at 160° C. to remove any residual ε-caprolactone. 546 g of an orange, viscous liquid product is obtained in a yield of 99%.

2) Ethoxylation of hbPEI800—1 CL/NH
a) To Obtain polymer 1.1.

80 g of hbPEI800—1 CL/NH as obtained in step 1) are filled into a steel pressure reactor and 1.5 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 120° C. and a mixture of 561 g of ethylene oxide and 117 g of ε-caprolactone are dosed into the reactor within ten hours. The mixture is allowed to post-react for six hours at 120° C. to remove any residual ethylene oxide and caprolactone. 738 g of a dark orange, viscous liquid product is obtained in a yield of 97%.

### b) To Obtain Polymer 1.2.

The same procedure as for polymer 1.1 was used for polymer 1.2. Instead of 117 g of caprolactone, here, 174.3 g of caprolactone were added. 807 g of a dark orange, viscous liquid product is obtained in a yield of 99%.

### ii) Comparative Example Ref.1

Sokalan® HP20 (Ref.1) is commercially available from BASF SE, Ludwigshafen, Germany and was used without modification.

### iii) Comparative Example Ref.2

The polymer Ref.2 has been prepared in a 2-step process:

### 1) Addition of ε-Caprolactone to Poly(Ethylene Imine)

50 g of poly(ethylene imine) with MW 800 (Lupasol® FG, commercially available from BASF

SE, Germany) are charged into a four-necked round bottom flask equipped with a cooler and a dripping funnel under nitrogen atmosphere. The product is heated to 80° C. and 267.7 g of ε-caprolactone is added slowly at 80° C. After caprolactone addition, the temperature is increased slowly to 160° C. and the mixture is allowed to post-react sixteen hours at 160° C. to remove any residual ε-caprolactone. 290 g of an orange, viscous liquid product is obtained in a yield of 91%.

2) Ethoxylation of hbPEI800—2 CL/NH

100 g of hbPEI800—2 CL/NH as obtained in step 1) are filled into a steel pressure reactor and 2.5 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 120° C. and 308 g of ethylene oxide are dosed into the reactor within five hours. The amount of ethylene oxide added is calculated based on the determined OH number of the educt hbPEI800—2 CL/NH. In Table 5, the amount of ethylene oxide is recalculated to obtain the equivalents of ethylene oxide added per NH-functionality of the poly(ethylene imine). The mixture is allowed to post-react for six hours at 120° C. to remove any residual ethylene oxide. 393 g of a dark orange, viscous liquid product is obtained in a yield of 96%.

The description of polymer hbPEI800—2 CL/NH—19 EO/NH is equal to polymer hbPEI800—2 CL/NH—25 EO/OH.

In the first description, the amounts of EO were recalculated to NH-functionality of the polyalkylene imine to be consistent with the definitions used in the claims and the description. In the second description, the actually used molar amounts of EO per determined OH number of the precursor are described.

### iv) Test Results of all Examples for Clay Stains Removal

The biodegradation of inventive polymers 1.1-1.2 is significantly improved versus Ref.1 and Ref.2, while polymer 1.1. even shows a biodegradation of ≥60% after 28 days in OECD 301F, i.e., is readily biodegradable.

### b) Synthesis of Examples for Oily/Fatty Stains Removal

An overview of the prepared examples can be found in Table 6.

TABLE 6
Overview of prepared examples for oily/fatty stains removal

| | | Biodegradability |
|---|---|---|
| | | (%, 28 d, |
| Polymer | Chemistry | OECD 301F) |
| Ref. 3 | hbPEI800 - 24 EO/NH - 16 PO/NH | <5 |
| Ref. 4 | hbPEI2000 - 2 CL/NH - 22 EO/NH - 15 | 49 |
| | PO/NH | |
| 2.1 | hbPEI800 - 1 CL/NH - (2 CL - mix - 25 | 57 |
| | EO)/NH - 13 PO/NH | |
| 2.2 | hbPEI2000 - 4 CL/NH - (3 CL - mix - 21 | 62 |
| | EO)/NH - 22 PO/NH | |

### i) Synthesis of Polymer 2.1

Polymer 2.1 has been prepared in a 3-step process:

1) Synthesis of hbPEI800—1 CL/NH

hbPEI800—1 CL/NH has been prepared according to step 1 of the process described for polymer 1.1 and 1.2.

2) Synthesis of hbPEI800—1 CL/NH—(2CL—mix—25 EO)/NH

hbPEI800—1 CL/NH—(2CL—mix—25 EO)/NH has been prepared according to step 2 of the process described for polymer 1.1.

3) Synthesis of hbPEI800—1 CL/NH—(2CL—mix—25 EO)/NH—13 PO/NH

250 g of hbPEI800—1 CL/NH—(2CL—mix—25 EO)/NH obtained in step 2) are filled into a steel pressure reactor and 0.9 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 130° C. and 216 g of propylene oxide are dosed into the reactor within six hours. The amount of propylene oxide added are calculated based on the determined OH number of the educt hbPEI800—1 CL/NH—(2 CL—mix—25 EO)/NH. The mixture is allowed to post-react for six hours at 130° C. to remove any residual propylene oxide. 444 g (95% yield) of a dark brown viscous liquid product were obtained. The description of polymer hbPEI800—1 CL/NH—(2 CL—mix—25 EO)/NH—13 PO/NH is equal to polymer hbPEI800—1 CL/NH—(2 CL—mix—25 EO)/NH—16 PO/OH.

### ii) Synthesis of Polymer 2.2

The polymer 2.2 was prepared in a 3-step process:

$$hbPEI 2000 - 4 CL / NH \qquad 1 )$$

120 g of poly(ethylene imine) with MW 2000 (Lupasol® PR8515, commercially available from BASF SE, Germany) are charged into a four-necked round bottom flask equipped with a cooler and a dripping funnel under nitrogen atmosphere. The product is heated to 80° C. and 1285 g of ε-caprolactone per NH-functionality of the poly(ethylene imine) is added slowly at 80° C. After ε-caprolactone addition, the temperature is increased slowly to 160° C. and the mixture is allowed to post-react for sixteen hours at 160° C. to remove any residual ε-caprolactone. 1422 g of a dark viscous liquid product is obtained in a yield of 94%.

$$hbPEI 2000 - 4 CL / NH - ( 3 CL - mix - 21 EO ) / NH \qquad 2 )$$

200 g of hbPEI2000—4 CL/NH as obtained in step 1) are filled into a steel pressure reactor and 4.0 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 120° C. and 363 g of ethylene oxide and 94 g-caprolactone are dosed into the reactor within eight hours. The mixture is allowed to post-react for six hours at 120° C. to remove any residual ethylene oxide and caprolactone. 642 g of a dark orange, viscous liquid product were obtained in a yield of 98%.

$$hbPEI 2000 - 4 CL / NH - ( 3 CL - mix - 21 EO ) / NH - ( 22 PO ) / NH \qquad 3 )$$

250 g of hbPEI2000—4 CL/NH—(3 CL—mix—21 EO)/NH are filled into a steel pressure reactor and 2.3 g of potassium methanolate (32.5 wt % in methanol) are added. Methanol is removed at 20 mbar at 80° C. The reactor is purged with nitrogen to remove air and a nitrogen pressure of 2 bar is set. The reactor is heated to 130° C. and 373 g of propylene oxide are dosed into the reactor within ten hours. The amount of propylene oxide added is calculated based on the determined OH number of the educt hbPEI2000—4 CL/NH—(3 CL—mix—21 EO)/NH. The mixture is allowed to post-react for six hours at 130° C. to remove any residual propylene oxide. 594 g (95% yield) of a dark orange solid product were obtained.

The description of polymer hbPEI2000—4 CL/NH—(3 CL—mix—21 EO)/NH—22 PO)/NH is equal to polymer hbPEI2000—4 CL/NH—(3 CL—mix—30 EO)/OH—30 PO/OH.

### iii) Comparative Example Ref.3

Ref.3 is prepared in a 3-step process:

$$hbPEI 800 + 0 , 9 EO / NH \qquad 1 )$$

400 g of poly(ethylene imine) with MW 800 (Lupasol® FG, commercially available from BASF SE, Ludwigshafen, Germany) and 40 g distilled water are charged to a steel pressure reactor. The reactor is purged with nitrogen to remove air and a nitrogen pressure of 2 bar is set. The reactor is then heated to 100° C. and 369 g of ethylene oxide are dosed into the reactor within 4 hours. After that, the reaction mixture is kept at 100° C. for post reaction. Volatile compounds are removed under vacuum and 766 g (99% yield) of a yellowish, solid product is isolated from the reactor.

$$hbPEI 800 + 24 EO / NH \qquad 2 )$$

100 g hbPEI800+0.9 EO/NH from step 1) are filled into a steel pressure reactor and 9.9 g of potassium hydroxide (50 wt %) are added. Water is removed at 20 mbar at 80° C. The reactor is purged with nitrogen to remove air and a nitrogen pressure of 2 bar is set. The reactor is heated to 120° C. and 1232 g of ethylene oxide are dosed into the reactor within twelve hours. The mixture is allowed to post-react for four hours at 120° C. to remove any residual ethylene oxide. 1335 g (100% yield) of a dark orange, viscous liquid product were obtained.

$$hbPEI 800 + 24 EO / NH + 16 PO / NH \qquad 3 )$$

700 g hbPEI800+24 EO/NH from step 2) are filled into a steel pressure reactor and 2.6 g of potassium hydroxide (50 wt %) are added. Water is removed at 20 mbar at 80° C. The reactor is purged with nitrogen to remove air and a nitrogen pressure of 2 bar is set. The reactor is heated to 130° C. and 592 g of propylene oxide are dosed into the reactor within ten hours. The mixture is allowed to post-react for four hours at 130° C. to remove any residual propylene oxide. 1274 g (98% yield) of a dark orange, viscous liquid product were obtained.

### iv) Comparative Example Ref.4

The polymer Ref.4 has been prepared in a 2-step process:

### 1) Addition of ε-Caprolactone to Poly(Ethylene Imine)

Typically, 100 g of poly(ethylene imine) with MW 2000 (Lupasol® PR8515, commercially available from BASF SE, Germany) are charged into a four-necked round bottom flask equipped with a cooler and a dripping funnel under nitrogen atmosphere. The product is heated to 80° C. and the respective volume of ε-caprolactone per NH-functionality of the poly(ethylene imine) is added slowly at 80° C. After ε-caprolactone addition, the temperature is increased slowly to 160° C. and the mixture is allowed to post-react sixteen hours at 160° C. to remove any residual ε-caprolactone. Typically, a light brown, highly viscous liquid product is obtained in a yield >90%.

2) Alkoxylation of hbPEI2000—2 CL/NH

Typically, 100 g of the previously obtained hbPEI2000—2 CL/NH are filled into a steel pressure reactor and 0.2 wt % of potassium methanolate (32.5 wt % in methanol) based on the total end product volume are added. Methanol is removed at 20 mbar at 80° C. The reactor is purged with nitrogen to remove air and a nitrogen pressure of 2 bar is set. The reactor is heated to 130° C. and the respective volume of ethylene oxide are dosed into the reactor within eight hours. The mixture is allowed to post-react for three hours at 130° C. to remove any residual ethylene oxide. Then, the respective volume of propylene oxide are dosed into the reactor within six hours. The mixture is allowed to post-react for six hours at 130° C. to remove any residual propylene oxide. The amount of ethylene oxide and propylene oxide added is calculated based on the determined OH number of the educt hbPEI2000—2 CL/NH. In Table 6, the amount of alkylene oxide is recalculated to obtain the equivalents of ethylene oxide and propylene oxide, respectively, added per NH-functionality of the poly(ethylene imine). Typically, a light brown, highly viscous liquid product is obtained in a yield >90%.

The description of polymer hbPEI2000—2 CL/NH—22 EO/NH—15 PO/NH is equal to polymer hbPEI2000—2 CL/NH—30 EO/OH—20 PO/OH.

In the first description, the amounts of EO and PO were recalculated to the NH-functionality of the polyalkylene imine to be consistent with the definitions of the claims and description of this patent application. In the second description, the actually used molar amounts of EO per determined OH number of the precursor are described.

### v) Test Results on all Oily/Fatty Stains Removal Polymers 2.1-2.2

The biodegradability of polymers 2.1.-2.2 was significantly improved as compared to Ref.3 and Ref.4, while polymer 2.2 even shows a biodegradation of ≥60% after 28 days in OECD 301F, i.e., is readily biodegradable.

### 1) Characterization of the Inventive Polymers and the Comparative Examples

The identity of the obtained inventive polymers was confirmed by 1H- and 13C-NMR spectroscopy in deuterated methanol. 1H-NMR spectra are recorded with a Bruker AV-401 instrument at room temperature. 13C-NMR spectra are recorded with a Bruker AV-401 instrument at room temperature.

Molecular weights of the inventive polymers and the comparative examples may be determined by gel permeation chromatography (GPC). The measurements may be carried on a combination of two columns (styrene-divinylbenzene and polyester copolymer, both 25 cm in length and 4.6 mm in diameter), using 0.05 wt % potassium trifluoroacetate in hexafluoroisopropanol as eluent. The molecular weights may be obtained by using an RI detector and PEO standards (Polymer Laboratories/Agilent, USA) for calibration. In addition, the absolute molar mass may be determined by multi angle light scattering (MALLS).

OH numbers of the inventive polymers and their intermediates were determined according to a BASF internal procedure in alignment with the respective ISO standard.

Amine numbers were determined according to the method described in DIN 16945.

### 2) Biodegradation Data

Biodegradation in wastewater was tested in triplicate using the OECD 301F manometric respirometry method. OECD 301F is an aerobic test that measures biodegradation of a sample by measuring the consumption of oxygen. To a measured volume of medium, 100 mg/L test substance, which is the nominal sole source of carbon is added along with the inoculum (30 mg/L, aerated sludge taken from Mannheim wastewater treatment plant). This is stirred in a closed flask at a constant temperature (20° C. or 25° C.) for 28 or 56 days, respectively. The consumption of oxygen is determined by measuring the change in pressure in the apparatus using an OxiTop® C (Xylem 35 Analytics Germany Sales GmbH & Co KG). Evolved carbon dioxide is absorbed in a solution of sodium hydroxide. Nitrification inhibitors are added to the flask to prevent usage of oxygen due to nitrification. The amount of oxygen taken up by the microbial population during biodegradation of the test substance (corrected for uptake by blank inoculum, run in parallel) is expressed as a percentage of ThOD (Theoretical oxygen demand, which is measured by the elemental analysis of the compound). A positive control Glucose/Glucosamine is run along with the test samples for each cabinet.

### 3) Application Experiments

Table 7 shows the base liquid laundry detergent w/o any polymer (LLD.1) that has been used to carry out the application tests to determine the impact of the inventive polymers on the primary cleaning performance.

TABLE 7
Composition of the base liquid laundry detergent.

| Ingredients | LLD.1 * |
|---|---|
| Linear C₁₂C₁₄-alkylbenzenesulfonic acid | 5.50 |
| C₁₂-fatty alcohol × 2 EO sulfate | 5.40 |
| C₁₂C₁₅-fatty alcohol × 7 EO | 5.40 |
| Coconut C12-C18 fatty acid | 2.40 |
| Sodium hydroxide | 2.20 |
| 1,2-Propylene glycol | 6.00 |
| Ethanol | 2.00 |
| Sodium citrate | 3.00 |
| Demin. water | add 100 |
| pH value | 8.5 |

*) All data are wt % active ingredient, independent of the respective product form.

### Primary Cleaning Performance on Particulate Stains

To determine the primary detergency, the cleaning performance on 4 different particulate stains on a polyester fabric (CFT, Vlaardingen, The Netherlands) was measured by determining the color difference (delta E) between the stains after wash and the unsoiled white fabric using a reflectometer (Mach5 plus, a multi area color measurement instrument from ColourConsult). Each experiment containing the 4 different circular particulate stains (Clay ground soil, Standard clay, Red pottery clay, Tennis court clay; All 4 stains on one polyester fabric, 2 of those fabrics per wash) was repeated 3 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive modified alkoxylated polyalkylene imine, or the comparative polymer, respectively, vs. the laundry detergent w/o any modified alkoxylated polyalkylene imine, or comparative polymer, respectively.

Table 8 shows the washing test conditions and Table 9 summarizes the obtained standardized cleaning performance. The standardized cleaning performance shown in Table 9 is the sum of the standardized cleaning performance of all 4 stains. The bigger the sum of the delta delta E value, the bigger the positive contribution of the inventive modified alkoxylated polyalkylene imine or the comparative polymer, respectively, vs. the laundry detergent w/o any modified alkoxylated polyalkylene imine or comparative polymer, respectively, on the cleaning performance.

TABLE 8
Washing conditions for evaluation of primary cleaning performance on particulate stains.

| Washing conditions | | |
|---|---|---|
| Device | Launder-O-Meter from SDL Atlas, Rock Hill, | |
| | USA | |
| Washing liquor | 250 | mL |
| Washing time | 30 | minutes |
| Washing temperature | 30° | C. |
| Detergent concentration | 3.0 | g/L |

| | |
|---|---|
| Water hardness (Ca:Mg:HCO3) | 1.2 mmol/L (4:1:8) (7 °dH) |
| Fabric to liquor ratio | 1:10 |
| Modified alkoxylated polyalkylene imine or | 3% by weight (vs. liquid laundry detergent) of |
| comparative polymer, respectively | the polymer, 100% active ingredient |
| Test fabric * | 4 different circular particulate stains (P-H018, P- |
| | H115, P-H144, P-H145) (CFT, Vlaardingen, |
| | The Netherlands) on one polyester fabric; 2 |
| | stained fabrics per wash |
| Ballast fabric | 2.5 g SBL 2004 (Soil Ballast Fabric ‘Formula |
| | 2004’ that simulates sebum grease stains; WFK |
| | Testgewebe GmbH, Brueggen, Germany); +additional |
| | white cotton ballast |

*) After the washing experiment, the test fabrics were rinsed with tap water followed by drying at ambient room temperature overnight, prior to the measurement with the Mach5 plus.

TABLE 9
Results from washing tests (primary cleaning
performance on particulate stains).

| | | | Standardized cleaning |
|---|---|---|---|
| | | Concentration of | performance (sum delta |
| Detergent | Polymer | polymeric additive * | delta E) |
| LLD.1 | 1.1 | 3 wt % | 10.7 |
| LLD.1 | 1.2 | 3 wt % | 9.9 |
| LLD.1 | Ref. 1 | 3 wt % | 12.8 |
| LLD.1 | Ref. 2 | 3 wt % | 11.2 |

*) All data are wt % active ingredient, independent of the respective product form.

### Test Results:

The error of the measurement is +/−2 delta delta E units. Therefore, any value >2 (sum delta delta E) means that the respective polymer exhibits a directional and visible contribution to the overall cleaning performance of the respective detergent formulation; Any value >4 (sum delta delta E) means that the respective polymer exhibits even a significant contribution to the overall cleaning performance, i.e., the respective polymer leads to a significant improvement of the formulation. All polymers (inventive and comparative) exhibit significant cleaning benefits on particulate stains.

The wash performance of the inventive modified alkoxylated poly(ethylene imine) samples 1.1-1.2 was comparable to Sokalan® HP20 (Ref.1), considering the error of the measurement.

### Primary Cleaning Performance on Oily/Fatty Stains

To determine the primary detergency, the cleaning performance on 16 different oily/fatty stains on cotton, polycotton and polyester fabrics (CFT, Vlaardingen, The Netherlands) was measured by determining the color difference (delta E) between the stains after wash and the unsoiled white fabric using a reflectometer (Mach5 plus, a multi area color measurement instrument from ColourConsult). Each experiment containing the 16 different circular oily/fatty stains (Lipstick, Make-Up, Beef Fat, Frying Fat, Burnt Butter, Palm Oil, Sebum BEY, Sebum Tefo, Collar Stain; All on different fabrics) was repeated 6 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive modified alkoxylated polyalkylene imine or the comparative polymer, respectively, vs. the laundry detergent w/o any modified alkoxylated polyalkylene imine or comparative polymer, respectively.

Table 10 shows the washing test conditions and Table 11 summarizes the obtained standardized cleaning performance. The standardized cleaning performance shown in Table 11 is the sum of the standardized cleaning performance of all 16 stains. The bigger the sum of the delta delta E value, the bigger the positive contribution of the inventive modified alkoxylated polyalkylene imine or the comparative polymer, respectively, vs. the laundry detergent w/o any modified alkoxylated polyalkylene imine or comparative polymer, respectively, on the cleaning performance.

TABLE 10
Washing conditions for evaluation of primary cleaning performance on oily/fatty stains.

| Washing conditions | | |
|---|---|---|
| Device | Launder-O-Meter from SDL Atlas, Rock Hill, USA | |
| Washing liquor | 250 | mL |
| Washing time | 60 | minutes |
| Washing temperature | 30° | C. |
| Detergent concentration | 3.0 | g/L |

| | |
|---|---|
| Water hardness (Ca:Mg:HCO3) | 2.5 mmol/L (4:1:8) (14 °dH) |
| Fabric to liquor ratio | 1:10 |
| Modified alkoxylated polyalkylene | 2.83% by weight (vs. liquid laundry detergent) of the |
| imine or comparative polymer, | polymer, 100% active ingredient |
| respectively | |
| Test fabric * | 16 different circular oily/fatty stains (KC-H122, KC-H176, |
| | KC-H015, KC-H187, PC-H082, PC-H212, PC-H210, PC- |
| | H252, P-H122, P-H129, P-H015, P-H187, P-H082, P- |
| | H212, P-H210, P-H252) (CFT, Vlaardingen, The |
| | Netherlands) |
| Ballast fabric | Polyester and cotton ballast, to yield a 1:1 ratio of |
| | polyester/cotton fabric per experiment |

*) After the washing experiment, the test fabrics were rinsed with 14 °dH water (2 times), followed by drying at ambient room temperature overnight, prior to the measurement with the Mach5 plus.

TABLE 11
Results from washing tests (primary cleaning
performance on oily/fatty stains).

| | | | Standardized cleaning |
|---|---|---|---|
| | | Concentration of | performance (sum delta |
| Detergent | Polymer | polymeric additive * | delta E) |
| LLD.1 | 2.1 | 2.83 wt % | 53.2 |
| LLD.1 | 2.2 | 2.83 wt % | 70.5 |
| LLD.1 | Ref. 3 | 2.83 wt % | 75.6 |
| LLD.1 | Ref. 4 | 2.83 wt % | 32.6 |

*) All data are wt % active ingredient, independent of the respective product form.

### Test Results:

The error of the measurement is +/−10 delta delta E units. Therefore, any value >10 (sum delta delta E) means that the respective polymer exhibits a directional and visible contribution to the overall cleaning performance of the respective detergent formulation; Any value >20 (sum delta delta E) means that the respective polymer exhibits even a significant contribution to the overall cleaning performance, i.e., the respective polymer leads to a significant improvement of the formulation. All polymers (inventive and comparative) exhibit significant cleaning benefits on oily/fatty stains.

Both inventive modified alkoxylated poly(ethylene imine) samples 2.1 and 2.2 showed significantly better wash performance compared to reference sample Ref.4, considering the error of the measurement. The wash performance of the inventive modified alkoxylated poly(ethylene imine) sample 2.2 was also comparable to reference sample Ref.3.

1. A modified alkoxylated polyalkylene imine or modified alkoxylated polyamine obtained by a process comprising the steps a) to e) as follows:
a) reacting 1) at least one polyalkylene imine or at least one polyamine comprising in total a plurality of primary and secondary amino groups with 2) at least one first lactone (LA1) and/or at least one first hydroxy carbon acid (HA1), wherein 1 to 10 mol of lactone (LA1) and/or of hydroxy carbon acid (HA1) is employed per mol of NH-functionality of polyalkylene imine or polyamine, in order to obtain a first intermediate (I1),
b) reacting the first intermediate (I1) (i) with at least one first alkylene oxide (AO1) or (ii) with a mixture of 1) at least one first alkylene oxide (AO1) with 2) at least one second lactone (LA2) and/or at least one second hydroxy carbon acid (HA2), wherein at least 5.0 mol of first alkylene oxide (AO1) and for the mixture additionally at least 1.0 mol of second lactone (LA2) and/or second hydroxy carbon acid (HA2) is employed per mol of NH-functionality of polyalkylene imine or polyamine, as employed in step a), in order to obtain a second intermediate (I2),
c) optionally reacting the second intermediate (I2) (i) with at least one second alkylene oxide (AO2) or (ii) with a mixture of 1) at least one second alkylene oxide (AO2) with 2) at least one third lactone (LA3) and/or at least one third hydroxy carbon acid (HA3), wherein at least 5.0 mol of second alkylene oxide (AO2) and for the mixture additionally at least 1.0 mol of third lactone (LA3) and/or third hydroxy carbon acid (HA3) is employed per mol of NH-functionality of polyalkylene imine or polyamine, as employed in step a), in order to obtain a third intermediate (I3),
d) optionally reacting the second intermediate (I2) or third intermediate (I3) with at least one fourth lactone (LA4) and/or at least one fourth hydroxy carbon acid (HA4), wherein at least 1.0 mol of fourth lactone (LA4) and/or fourth hydroxy carbon acid (HA4) is employed per mol of NH-functionality of polyalkylene imine or polyamine, as employed in step a), in order to obtain a fourth intermediate (I4), and
e) optionally reacting the second intermediate (I2), third intermediate (I3) or fourth intermediate (I4) with at least one C1-C₁₈ alkylation or esterification reagent, in order to obtain the modified alkoxylated polyalkylene imine or the modified alkoxylated polyamine,
wherein the amount of second, third and/or fourth lactones and/or the amount of second, third and/or fourth hydroxy carbon acids is at least 1 mol per mol of NH-functionality of polyalkylene imine or polyamine, as employed in step a), and
wherein the total amount of first, second, third and/or fourth lactones and/or the total amount of first, second, third and/or fourth hydroxy carbon acids is at least 2 mol per mol of NH-functionality of polyalkylene imine or polyamine, as employed in step a), and
wherein
(i) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located terminally, and/or
(ii) not more than 50% of the at least one second lactone (LA2), the at least one second hydroxy carbon acid (HA2), the at least one third lactone (LA3), the at least one third hydroxy carbon acid (HA3), the at least one fourth lactone (LA4) and the at least one fourth hydroxy carbon acid (HA4) are located adjacent to each other,
wherein a mixture of 1) at least one alkylene oxide (AO1, AO2) with 2) at least one lactone (LA2, LA3) and/or at least one hydroxy carbon acid (HA2, HA3) is applied in at least one of the steps b) and/or c).

2. The modified alkoxylated polyalkylene imine or modified alkoxylated polyamine according to claim 1, wherein the at least one polyalkylene imine or the at least one polyamine comprises at least 2, 3, 4, 5, 6, 7, 8, 9 or more primary and/or at least 1, 2, 3, 4, 5, 6, 7, 8, 9 or more secondary amino groups and wherein in the modified alkoxylated polyalkylene imine or modified alkoxylated polyamine more than 50% of said primary and/or secondary amino groups are reacted with the first lactone (LA1) and/or the first hydroxy carbon acid (HA1) to form an amide bond.

3. The modified alkoxylated polyalkylene imine or modified alkoxylated polyamine according to claim 1 comprising a plurality of alkoxy chains, wherein at least 50% of said alkoxy chains comprise a structure according to formula (IV) 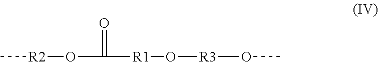
wherein
the dotted lines indicate the bonds between the structure of formula (IV) and the alkoxy chain,
R1 represents linear or branched C2-C10-alkylene radicals;
R2 represents linear or branched C2-C12-alkylene radicals; and
R3 represents linear or branched C2-C12-alkylene radicals.

4. The modified alkoxylated polyalkylene imine or modified alkoxylated polyamine according to claim 1, wherein the polyalkylene imine or polyamine of step a) is defined according to formula (I) 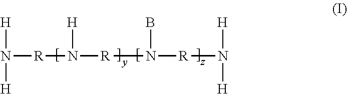
in which the variables are each defined as follows:
R represents identical or different i) linear or branched C₂-C₁₂-alkylene radicals or ii) an etheralkyl unit of the following formula (III): 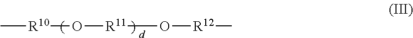
in which the variables are each defined as follows:
R¹⁰, R¹¹, R¹² represent identical or different, linear or branched C₂-C₆-alkylene radicals and
d is an integer having a value in the range of from 0 to 50,
B represents
(i) a continuation of the polyalkylene imine or polyamine by branching; and/or
(ii) identical or different C1-C18-alkyl;
y is an integer having a value of at least 1, and
Z is an integer having a value of 0-150.

5. The modified alkoxylated polyalkylene imine or modified alkoxylated polyamine according to claim 4, wherein the modified alkoxylated polyalkylene imine or modified alkoxylated polyamine comprises a structural element according to formulas (Ia) and/or (Ib) 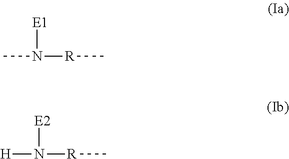
for both formulas the variables are defined as follows:
the dotted lines indicate bonds to the remaining parts of the modified alkoxylated polyalkylene imine or modified alkoxylated polyamine;
E1 and E2 represent a residue according to formula (IIa) 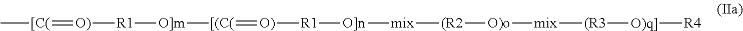
wherein -mix- defines that the flanking units are randomly distributed among each other, wherein m is an integer having a value of 1-10, n is an integer having a value of 1-10, o is an integer having a value of 5-100, q is an integer having a value of 0 or a value of 5-100, wherein the sum of m and n (m+n) is at least 2, and
R1 represents linear or branched C₂-C₁₀-alkylene radicals;
R2 represents linear or branched C₂-C₁₂-alkylene radicals;
R3 represents linear or branched C₂-C₁₂-alkylene radicals; and
R4 represents hydrogen, unsubstituted or at least monosubstituted C₁-C₁₈-alkyl, C₇-C₁₈-aralkyl, —(CO)—C₁-C₁₈-alkyl, —(CO)—C₂-C₁₈-alkenyl and/or —(CO)—C₇-C₁₈-aralkyl, wherein the substituents are selected from the group consisting of —COOH or a salt thereof,
wherein R² and R³ are not identical.

6. The modified alkoxylated polyalkylene imine or modified alkoxylated polyamine according to claim 1, wherein
i) all steps a) to e) are carried out as a one-step reaction, optionally in the of presence of a catalyst, and/or
ii) the weight average molecular weight (Mw) of the polyalkylene imine or of the polyamine employed in step a) lies in the range of from 50 to 20 000 g/mol.

7. The modified alkoxylated polyalkylene imine according to claim 4, wherein the variables are each defined as follows:
R is ethylene and/or propylene; and
the sum of y+z is an integer having a value in the range of 4 to 200.

8. The modified alkoxylated polyalkylene imine or modified alkoxylated polyamine according claim 1, wherein up to 100% of the nitrogen atoms present in the modified alkoxylated polyalkylene imine or modified alkoxylated polyamine are further quaternized.

9. The modified alkoxylated polyalkylene imine or modified alkoxylated polyamine according to claim 1, wherein
i) in step a) the first lactone (LA1) is caprolactone or lactide, and/or
ii) in step a) the first hydroxy carbon acid (HA1) is lactic acid or glycolic acid, and/or
iii) in step b) (i) and (ii) the first alkylene oxide (AO1) is ethylene oxide or a mixture of ethylene oxide and propylene oxide or a mixture of ethylene oxide and butylene oxide, and/or in step b) (ii) the second lactone (LA2) is caprolactone or lactide, and/or the second hydroxy carbon acid (HA2) is lactic acid or glycolic acid, and/or
iv) in step c) (i) and (ii) the second alkylene oxide (AO2) is propylene oxide or a mixture of propylene oxide and ethylene oxide or a mixture of propylene oxide and butylene oxide, and/or in step c) (ii) the third lactone (LA3) is caprolactone or lactide, and/or the third hydroxy carbon acid (HA3) is lactic acid or glycolic acid, and/or
v) in step d) the fourth lactone (LA4) is caprolactone or lactide, and/or
vi) in step d) the fourth hydroxy carbon acid (HA4) is lactic acid or glycolic acid.

10. The modified alkoxylated polyalkylene imine or modified alkoxylated polyamine according to claim 1, wherein
i) in steps b) (i), b) (ii), c) (i) and/or c) (ii) in total 5 to 100 mol of alkylene oxide (AO1 and/or AO2) is employed per mol of NH-functionality of polyalkylene imine or polyamine, wherein more than 70 mol % of the alkylene oxide is based on ethylene oxide, and/or
ii) in steps a), b) (ii), c) (ii) and/or d) in total 2 to 10 mol of lactone (LA1, LA2, LA3 and/or LA4) and/or 2 to 20 mol of hydroxy carbon acid (HA1, HA2, HA3 and/or HA4) is employed per mol of NH-functionality of polyalkylene imine or polyamine.

11. The modified alkoxylated polyalkylene imine or modified alkoxylated polyamine according to claim 1, wherein
i) in steps b) (i), b) (ii), c) (i) and/or c) (ii) in total 25 to 120 mol of alkylene oxide (AO1 and/or AO2) is employed per mol of NH-functionality of polyalkylene imine or polyamine, whereas less than 70 mol % of the alkylene oxide is based on ethylene oxide,
ii) in steps a), b) (ii), c) (ii) and/or d) in total 2 to 10 mol of lactone (LA1, LA2, LA3 and/or LA4) and/or 2 to 20 mol of hydroxy carbon acid (HA1, HA2, HA3 and/or HA4) is employed per mol of NH-functionality of polyalkylene imine or polyamine.

12. The modified alkoxylated polyalkylene imine or modified alkoxylated polyamine according to claim 1, wherein
(1) in step a) the at least one polyalkylene imine is polyethylene imine with a weight average molecular weight (Mw) ranging from 500 g/mol to 1000 g/mol, wherein 1 to 5 mol of caprolactone is employed per mol of NH-functionality of polyalkylene imine; and in step b) (ii) a mixture of 15 to 40 mol of ethylene oxide and 1 to 3 mol of caprolactone is employed per mol of NH-functionality of polyalkylene imine, wherein in total at least 2 mol of caprolactone is employed per mol of NH-functionality polyalkylene imine; or
(2) in step a) the at least one polyalkylene imine is polyethylene imine with a weight average molecular weight (Mw) ranging from 1500 g/mol to 2500 g/mol, wherein 1 to 5 mol of caprolactone is employed per mol of NH-functionality of polyalkylene imine; and in step b) (i) 15 to 40 mol of ethylene oxide is employed per mol of NH-functionality of polyalkylene imine; and in step c) (ii) a mixture of 15 to 40 mol of propylene oxide and 1 to 3 mol of caprolactone is employed per mol of NH-functionality of polyalkylene imine; wherein the molar ratio of ethylene oxide to propylene oxide ranges from 1.5:1 to 1:1.5 and wherein in total at least 2 mol of caprolactone is employed per mol of NH-functionality polyalkylene imine; or
(3) in step a) the at least one polyalkylene imine is polyethylene imine with a weight average molecular weight (Mw) ranging from 4000 g/mol to 6000 g/mol, wherein 1 to 5 mol of caprolactone is employed per mol of NH-functionality of polyalkylene imine; and in step b) (i) 15 to 40 mol of ethylene oxide is employed per mol of NH-functionality of polyalkylene imine; and in step c) (ii) a mixture of 15 to 40 mol of propylene oxide and 1 to 3 mol of caprolactone is employed per mol of NH-functionality of polyalkylene imine; wherein the molar ratio of ethylene oxide to propylene oxide ranges from 1.5:1 to 1:1.5, wherein in total at least 2 mol of caprolactone is employed per mol of NH-functionality polyalkylene imine.

13. The modified alkoxylated polyalkylene imine or modified alkoxylated polyamine according to claim 1, wherein said modified alkoxylated polyalkylene imine or modified alkoxylated polyamine demonstrates at least 20% biodegradability according to standard OECD 301F after at least 56 days.

14. A process to prepare a modified alkoxylated polyalkylene imine or modified alkoxylated polyamine, the process comprising carrying out the process steps according to claim 1.

15. A method of using the modified alkoxylated polyalkylene imine or modified alkoxylated polyamine according to claim 1, the method comprising using the modified alkoxylated polyalkylene imine or modified alkoxylated polyamine in cleaning compositions, in fabric and home care products, in cosmetic formulations, as a crude oil emulsion breaker, in pigment dispersions for ink jet inks, in formulations for electro plating, in cementitious compositions, or as a dispersant for agrochemical formulations.

16. The method according to claim 15, the method comprising using the modified alkoxylated polyalkylene imine or modified alkoxylated polyamine in cleaning compositions and/or in fabric and home care products for
i) clay removal, and/or
ii) improved removal of oily/fatty stains, and/or
iii) soil removal of particulate stains, and/or
iv) dispersion and/or emulsification of soils, and/or
v) modification of treated surface to improve removal upon later re-soiling, and/or
vi) whiteness improvement and/or
vii) when at least one enzyme selected from the group consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types is present, additionally for improvement of removal of oily/fatty stains, food stain removal and/or removal of complex stains.

17. A cleaning composition, a fabric and home care product, an industrial and institutional cleaning product, a cosmetic formulation, a crude oil emulsion breaker, a pigment dispersion for ink jet inks, a formulation for electro plating, a cementitious composition, or a dispersant for agrochemical formulations, comprising at least one modified alkoxylated polyalkylene imine or modified alkoxylated polyamine according to claim 1.

18. The cleaning composition according to claim 17 comprising the at least one modified alkoxylated polyalkylene imine or modified alkoxylated polyamine, at least one anionic surfactant, and water.

19. The cleaning composition according to claim 17 further comprising
(a) an antimicrobial agent selected from the group consisting of 2-phenoxyethanol and 4,4′-dichloro 2-hydroxydiphenylether; and/or
(b) at least one enzyme selected from the group consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types.

20. The modified alkoxylated polyalkylene imine or modified alkoxylated polyamine according to claim 1, wherein the at least one polyalkylene imine or the at least one polyamine comprises at least 2, 3, 4, 5, 6, 7, 8, 9 or more primary and/or at least 1, 2, 3, 4, 5, 6, 7, 8, 9 or more secondary amino groups and wherein in the modified alkoxylated polyalkylene imine or modified alkoxylated polyamine at least 75% of said primary and/or secondary amino groups are reacted with the first lactone (LA1) and/or the first hydroxy carbon acid (HA1) to form an amide bond.
